(19) United States
(12) Patent Application Publication
(10) Pub. No.: US 2006/0229940 A1
(43) Pub. Date: Oct. 12, 2006

(54) Method of distributing printed advertising

(76) Inventor: James Grossman, Westport, CT (US)

Correspondence Address: RICHARD I. SAMUEL;GOODWIN PROCTER L.L.P, 599 LEXINGTON AVE., NEW YORK, NY, 10022, US

(21) Appl. No.: 11/365,003

(22) Filed: Feb. 28, 2006

Related U.S. Application Data
(63) Continuation of application No. 09/560,836, filed on Apr. 28, 2000.

(51) Int. Cl. G06Q 30/00

(52) U.S. Cl. 705/14

(57) ABSTRACT

A method and system for distributing printed advertising. Printed advertising may be pre-printed on printable paper sheets and leaving a printable field free of printed advertising on each of the plurality of sheets. The partially-printed paper is distributed to a plurality of users. Users access a website to confirm acquisition of the partially-printed paper. The website records usage of the partially-printed paper and increases a credit account associated with the user based on usage of the partially-printed paper. In an alternate method, the printed advertisement is formatted for marginal printing on printable paper sheets by a user's printer when a registered user downloads printed information via the Internet. A website records printing of the advertising information formatted for marginal printing and increases a credit account associated with the user based on printing of the advertising information formatted for marginal printing.

### FIELD OF THE INVENTION

The invention relates to the assembly, configuration and distribution of printed advertising.

### BACKGROUND OF THE ART

Institutions and businesses have been known to use advertisements to supplement funding for printed media. However, this method has not been implemented in a manner that takes full advantage of current technology and channels of distribution in a way that will readily be perceived by the consumer and business to provide a significant advantage and benefit.

In an economy that grows increasingly integrated with the Internet, and in which users download information in the form of printed copy on paper, there is presently a missed opportunity to place advertising messages directly into the user's home or place of business. It is therefore an object of this invention to provide a method of placing advertising messages physically into existing and potential customers' hands via two of the most widely used communications products and services, i.e., printable paper sheets and the worldwide network of computers commonly known as the Internet.

As used herein, the term “printable paper sheet” means conventional and unconventional paper in the grades and sizes customarily sold for use in computer printers, photocopy and stationary and mobile facsimile machines, mobile wireless devices and for padding in the manufacture of writing tablets. It also includes fan-folded and accordion-folded paper for use with computer printers, including paper with and without marginal line holes. It also includes any other printable medium in the form of a web or roll. Such papers are commonly sold in the United States in packs of 500 sheets measuring 8.5 inches in width and 11, 13 or 14 inches in length. A common letter sheet size used in Europe and elsewhere outside of the United States is identified as “A4” and measures 210 mm×297 mm. “Printable paper sheet” includes sheet and webs made from coated and plain cellulosic-based pulp, and synthetic and semi-synthetic materials, and polymers, so long as the surface is capable of receiving print or embedded information.

As used herein, the term “printable field” means any unprinted or blank area of a sheet that is adjacent to, surrounded by, and/or proximate to an area or areas on which advertising or promotional messages, text and/or indicia are printed.

As used herein, the term “central printable field” means a central area of a printable paper sheet that is blank or unprinted, that has top, bottom and/or opposing side marginal areas that border the central area.

As used herein, the term “user identifying information” means the user's name and mailing information, including postal address and/or e-mail address, telephone or other identifying indicia specific to a specific user, user group or business and can include special interest information, including product, services, classes or types of advertising of interest to the user.

As used herein, “advertising” encompasses its usual broad definition and includes advertisements in the form of text, slogans, trademarks, service marks, trade names, logos, promotional and sales announcements and information, specific and general information about products and services, addresses, maps, and all other forms of commercial speech that is proffered or paid for by a sponsor or third party and directed to, or intended for an unrelated user.

As used herein, the term “embedded” means that the advertising message, logo or other indicia is printed in one or more light-colored inks that can be overprinted without adversely affecting the legibility of the overprinted text, or appears as a faintly printed watermark, or is printed in a heat or light sensitive medium that is activated and becomes visible only after passing through the user's printer or upon exposure to natural or artificial light sources or other devices that allow viewing.

### SUMMARY OF THE INVENTION

In many instances, revenue is generated by the placement of advertisements in conjunction with web-based activities such as with banner ads and sponsored websites. However, there is an important advantage that is lost by not pre-printing or controlling the printing of ads on paper. Because it can be incorporated with the Internet or be exclusive from the Internet, the embodiments of the present invention can reach customers in a specific targeted way that other printed media cannot. It provides a new way for advertisers to reach and interact with businesses and consumers directly that has not been done before. It is a unique way to physically put an ad into the customer's hand and offers the advantages of a permanent record of the ad via a very cost-effective process.

In one preferred embodiment, the invention is used to particular advantage in conjunction with the Internet, although the method is not limited to the Internet. The method of the invention comprehends distribution of paper with advertisements pre-printed or embedded on the printable paper sheets that is either purchased off-the-shelf at retail, or specially ordered, or physically delivered to the user's home or place of business.

In an alternative preferred embodiment, a printable paper sheet is printed with ads as information is downloaded from the Internet for general use by any interested party. The user can register relevant information with a sponsor or other intermediary for the purpose of receiving advertising of a general or specifically selected nature when information is printed to hard copy by the user's computer printer or other printing device. As consideration, and in exchange for receiving the advertising in printed form, the user receives credits, points or premiums based, e.g., on the number of pages or promotions printed with advertising.

In another preferred embodiment of the invention, a printer that is used in conjunction with a computer is modified, e.g., by connecting a programmable integrated circuit (“IC”) device or equivalent means to the control circuit of a user's computer-directed printer for the purpose of adding one or more printed advertising messages to a predetermined printable field on the printable paper sheets passing through the printer. Alternatively, the IC device can be fabricated for installation in the computer's central processing unit (“CPU”) or printer for controlling the operation of the printer. Predetermined or random areas of the user's paper sheets are thereby allocated to receive printed advertising messages, leaving printable field constituting the rest of the sheet to receive printed information downloaded from the Internet, or otherwise created by the user in conjunction with the computer's word processing and/or other programs.

### BRIEF DESCRIPTION OF THE DRAWINGS

The novel features and advantages of the present invention in addition to those mentioned above, will become apparent to those skilled in the art from a reading of the following detailed description in conjunction with the accompanying drawings, in which:

FIG. 1 is a schematic illustration representing preferred embodiments of the method and apparatus of the invention;

FIG. 2 is a sheet of paper on which is schematically illustrated one preferred embodiment of the invention;

FIG. 3 is a sheet of paper on which is schematically illustrated a second preferred embodiment of the invention;.

FIG. 4 is a sheet of paper on which is schematically illustrated yet another preferred embodiment of the invention;

FIG. 5A is a partially pre-printed sheet of paper for use in the practice of another preferred embodiment of the invention;

FIG. 5B is the sheet of FIG. 5a on which has been printed data downloaded from the Internet;

FIG. 5C is a sheet similar to that of FIG. 5a illustrating another embodiment in which data is printed after downloading from the Internet;

FIG. 6 is a sheet of partially pre-printed paper similar to that of FIG. 5a on which data in various forms has been printed after downloading from the Internet to represent another embodiment of the invention;

FIG. 7A is another partially printed paper sheet adapted for use in another preferred embodiment of the invention;

FIG. 7B is a schematic illustration of a screen of a computer monitor with a display corresponding to the printed sheet of FIG. 7A;

FIG. 7C is the pre-printed paper sheet of FIG. 7A that has been printed with additional data downloaded from the Internet;

FIG. 7D is a schematic illustration of the screen of a computer monitor illustrative of the method of one preferred embodiment of the invention;

FIG. 7E is the sheet of paper of FIG. 7C on which has been printed additional data downloaded from the Internet during the practice of this embodiment of the invention;

FIG. 8A is a sheet of paper that has been partially printed with instructions for participating in a promotion or game in accordance with another preferred embodiment of the invention;

FIG. 8B is the sheet of FIG. 8A on which has been printed with additional data that has been downloaded from several Internet websites;

FIG. 8C is the sheet of FIG. 8B on which additional data has been printed by downloading from an Internet website;

FIG. 8D is the sheet of FIG. 8C that has been completed with additional data downloaded from the Internet;

FIG. 9A is a partially printed advertising piece in accordance with another preferred embodiment of the invention;

FIG. 9B is the sheet of FIG. 9A that has been partially completed at an interactive website maintained by the advertising sponsor;

FIG. 9C is the sheet of FIG. 9B that has been fully completed and printed with data downloaded from the Internet;

FIG. 9D is a sheet similar to that of FIG. 9C on which different data has been entered;

FIG. 9E is similar to that of FIG. 9C but contains different data downloaded from the Internet;

FIG. 10 is a schematic illustration of apparatus for use in a further preferred embodiment of the invention.

FIG. 11A is a schematic illustration of a display item that is a wrist watch that is adopted for use in a preferred method of the invention;

FIG. 11B is a schematic illustration of a sheet adapted for producing display inserts for use in the display item of FIG. 11A;

FIG. 11C shows a pair of display inserts following printing and removal from the sheet of FIG. 11B;

FIG. 11D is aside view in partial section of the display item of FIG. 11A schematically illustrating the insertion of a display insert of FIG. 11C;

FIG. 11E is the display item of FIG. 11A with both the display inserts of FIG. 11C in place;

FIG. 12A is a schematic illustration of a display item that is a decorative pin adapted for use in the practice of the invention;

FIG. 12B is a schematic illustration of a sheet adapted for producing display inserts for use in the display item of FIG. 12A;

FIG. 12C is the sheet of FIG. 12B that has been printed;

FIG. 12D is the display item of FIG. 12A which has been placed a printed display insert removed from the sheet of FIG. 12C;

FIG. 13A is a schematic illustration of a display item that is a sign holder adapted for use in the practice of the invention;

FIG. 13B shows a printable paper sheet with printed indicia on the display insert; and

FIG. 13C is the sign support of FIG. 13A with the printed display insert in place.

### DETAILED DESCRIPTION OF THE PREFERRED EMBODIMENTS OF THE INVENTION

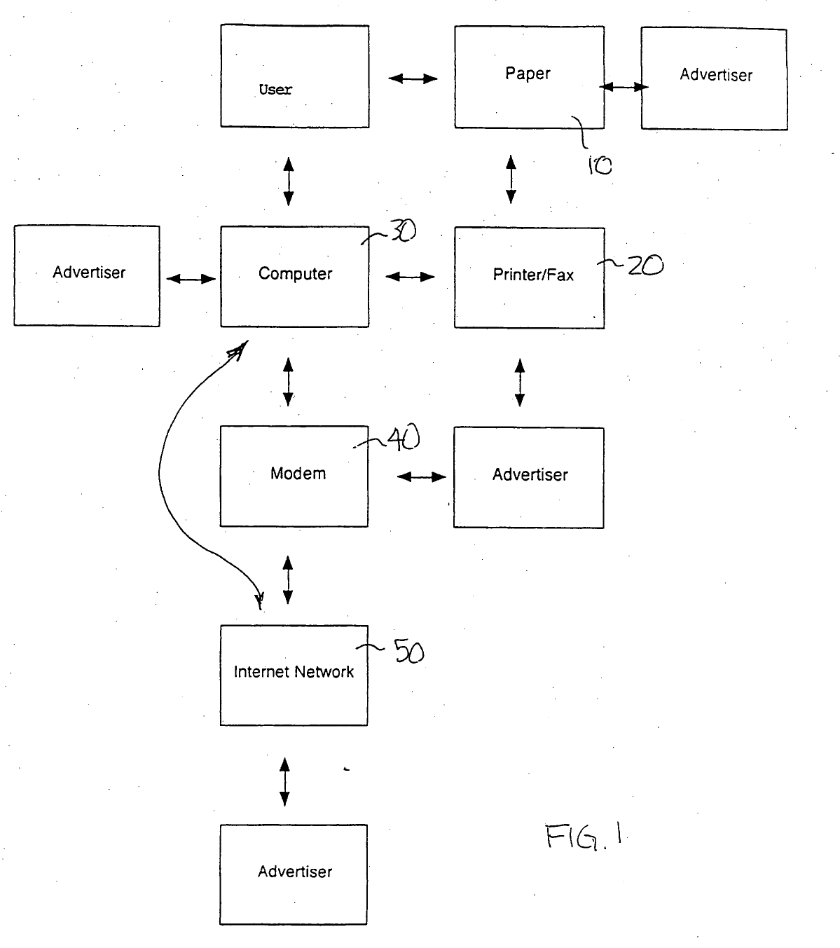

The following description and examples illustrate the preferred embodiments of the invention for distributing advertising and promotional information to a user via printable paper sheets that have printable fields onto which fields the user will cause printed or other information to be entered. As schematically illustrated in FIG. 1, the invention comprehends the use of apparatus and methods in which a user is provided with paper 10 on which advertising is printed ar various times and by various means, including by the interaction of the user's computer 30 and associated computer printer and/or fax 20, either by direct linking with the Internet 50 or by the intermediary of a modem 40 or related means.

Certain of the embodiments described below comprehend a method and system in which the user registers with an appropriate intermediary. For purposes of convenience and providing specific illustrative examples, the intermediary will be referred to as “Free2Print.com” which will be understood by those of ordinary skill in the art to be the domain name of an appropriately equipped hypothetical web site.

1. Printing of Advertising in Conjunction with the Internet

In a first embodiment of the invention, one or more advertising messages are transmitted to a user who is registered with Free2Print.com for the purpose of receiving the messages, i.e., a “registered user”, when information is downloaded from the Internet. In this embodiment, the advertising messages are printed by the user's computer, or other such device, at the same time, before, after or as part of the printing of the information on a printable paper sheet.

By means that are well known in the art, the sponsor or source of the advertising messages, or other intermediary, receives and maintains records relating to the number of sheets, promotions, or pages, printed by each of the registered users. This information relating to the number of sheets or advertising messages can be used for a number of varied and different purposes, as will be described in more detail below.

With pre-registered or registered paper, a person can receive paper with promotions on it, print from any website via Free2print.com, or can access any website or printer directly. Any printable means including letters, memos and e-mail initiated by the customer through Free2print.com or its affiliates, can be printed for credits or “Print Points”. Registration can also be completed via methods other than the Internet, such as telephone, regular mail, in person, or by any other conventional method. Furthermore, although the Internet can also be used to enhance the benefits of the product, the paper may be used independently and apart from the Internet, e.g., in combination with a variety of software programs.

Once the customer is registered, Free2print.com can provide an on-line credit, credit to a credit card account, transmit a rebate check for the cost of the paper, or provide options such as free paper, ink cartridges, printers, collateral premiums, and/or other combinations of products or services. Alternatively, special print-related discounts can be offered, e.g., after a certain number of paper sheets with promotions have been printed or pre-printed sheets have been used, printer ink or office supplies are offered to the registered user at or below cost.

By registering via the Free2print.com site with the use of portable equipment, disks or packs of paper, or downloading information, users can record the paper they use or ads received in the form of “Print Points” with corresponding rewards for different levels of points. The method of the invention can provide a new form of currency for the Internet than can be used on-line or off-line. This new web currency can be exchanged for other net currency or currencies, incentives or reward systems, or be redeemed for paper, for example, or for a variety of other items such as airline miles, products or services, etc. Points can be awarded based on the number of promotions or sheets printed, or the number of packs of paper registered or acquired with Free2print.com, or by using affiliated websites, or any of a variety of other methods and criteria. In one embodiment, Print Points can be redeemed for paper or for a variety of other items. A Free2print.com product line can be established offering different Free2print.com merchandise and promotional items which can also be offered via Free2print.com or affiliated websites. For example, Print Point affiliate sites can honor Print Points toward the purchase or exchange of products or services. Alternative means for accessing the Free2print.com website and associated Free2print.com points can include, e.g., barcodes, embedding paper, the use of finger prints, smart chips, voice activation systems, swiping a card, kiosks and membership centers. It is to be understood that Print Points need not be obtained or exchanged exclusively on the Internet and can be used independently of the Internet.

An individual or business user can register through Free2print.com, and can validate Free2print.com paper for personal or professional use. This paper can have ads provided by businesses, institutions, websites, printers, the government, individuals, etc., and can be put to any specific and/or general use. For example, a metropolitan railroad line can provide pre-printed paper with promotions featuring its services, have a blank field where a variety of train schedules can be filled in; airlines can provide ads that list information on flights; school districts can have public service messages and list school lunches for the week; movie theaters can give out Free2Print paper containing their ads allowing the customer to generate the names of the movies playing in local theaters and/or obtain reviews. The remaining central printable field of the paper is used for printing in real-time as information downloaded from the Internet, or for any other purpose desired, and the Print Points are credited to the registered user, group or individual who acquired the pre-printed paper and downloaded the advertisements.

Using the Internet as well as specific packaging and specific channels of distribution, it is possible to target paper purchasers and users by interest or geographic area, or a combination of both, in real-time. In accordance with the embodiment of the invention in which the user of the paper is registered, various elements constituting the user's identifying information can be made available to advertisers that choose to have options to send special offers to people who meet specified criteria. For example, for a particularly loyal registered user, the advertiser or paper supplier can offer to automatically replenish the user's paper supply or offer some other special bonus based on volume records indicating paper use and/or that the user has visited the advertiser's website or purchased his product.

If an advertiser wants to sell to a target audience or cater to the needs of individuals, they can make the most of all the Internet has to offer both on and offline by promoting a fixed portion of the ad and then customizing the balance of the advertisements. This is of particular significance for the method of the invention. For example, a television network that wants to promote a specific show or shows, can target time zones and viewing areas in a pre-printed advertisement and the specific information in the viewer's specific area based on region, demographics and other customer data is printed out by each individual and in conjunction with other ads. A national or regional chain of hardware stores promoting itself in the pre-printed portion of the ad that knows that a particular town is getting a heavy snowfall can feature its line of snow blowers instead of lawn mowers in the variable promotion area. Promotions can be changed moment to moment, hour to hour and day to day, permitting the owner of a local restaurant to promote the specials of the day or for the following day. A scheduled sale can be advertised for a specific time period, with the promotions being printed and circulated in only the area of the sale or in stores where the products are available. A different sale item can be featured every hour or every day, even changing the item(s) based the real-time on purchasing response, customer data, inventory, or store location.

In another example of this embodiment, paper is customized for use by families, e.g., special “grandchildren” paper, family paper, travel paper, vacation paper, local sports team paper, museum paper, art galleries, and the like. The paper could be customized for individuals with “homepage” paper that contains personally relevant ads that help pay for the paper it is printed on, encompassing a variety of the user/customer interests and needs.

An advertiser can choose to divide the page with an affiliate or company to cut advertising costs or to promote mutual interests, or it can choose to divide the page and have a game promotion that would allow a customer to go back to a particular website to fill in the other half of the offer. The page can be formatted to interactive games such as trivia, popular games, contests, connect the dots, paint-by-number or “guess who is in this picture”, with information where it can be completed or filled in with answers and pictures at various sites or websites. A picture can be half-printed and the other half can be completed at the advertiser's website.

Sheets or packs of contest paper can be provided with cash prizes via Free2Print.com. For example, users can be required to collect a series of numbers, graphics, words or data and collect all or some of the correct answers in order to win prizes. Contests can be established within specific time frames, days or hours, or the occurrence of specific events that can be completed as a Free2Print promotion. Contests can be established where many people are involved and several people enter the contest to complete the game from one or more sheets of paper therefore giving the ad a kind of collective participation and greater exposure, whereby a number of people participate in the process of the promotion. Contests and promotions can require players to access a specific number of websites to participate in the promotion and to determine its results. Visits to a specified number of websites can be required to complete puzzles such as crosswords, works of art, drawings or paintings. An advertiser can offer practical advice relating to one or more of its products, such as instructions for use, assembly information or health tips. Advertisers can provide Free2Print recipe paper and offer recipes based on the dietary or culinary preferences of the individual consumer. For example, Free2Print paper can be offered for diabetics, for people who are watching their cholesterol, for people who have food allergies, and the like.

2. Distribution of Paper with Pre-Printed Advertising

In this embodiment of the invention, printable paper sheets of the size, or sizes, customarily adapted for use in printers operated in conjunction with personal computers and mobile information devices are provided with one or more pre-printed advertising messages. The printable paper sheets with one or more pre-printed advertising messages are stacked and wrapped to form packages containing a predetermined number of pages, where some or all pages have a field of advertising and at least one blank area or printable field for non-advertising information that is generated by the user's printer. The pre-printed paper is distributed to users by any conventional means, including retail outlets, delivery service and the U.S. Postal Service.

The packaged paper is preferably provided with a label or other external indicia that identifies the nature or general subject matter, or category, of the advertising messages and the size of the blank or printable field that is available for printing information. The size of the printable field is used to set up the printer if it is desired to avoid overlap of the printed information and the pre-printed advertising messages.

It is to be understood that the advertising messages can be printed in light colored inks, in watermark formats, embedded by light-sensitive and heat-sensitive methods and by employing various other means well-known in the printing arts that will allow any information that overprints the pre-printed material to be legible and readable by person or machine. The advertising can be embedded via a computer chip or embossed via a raised area on the piece of paper, or can be printed in heat-activated inks that become visible when the paper is heated by the printer or exposed to a special light.

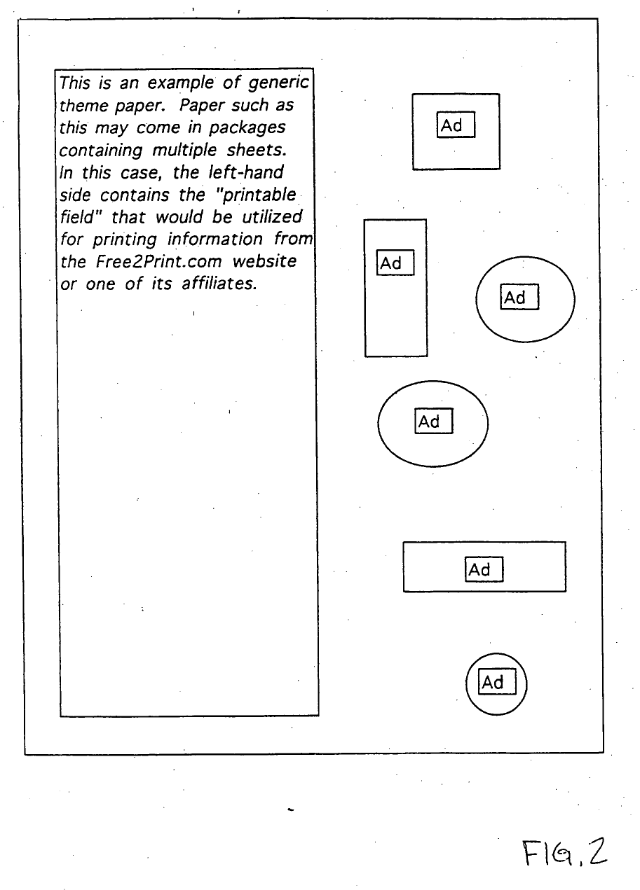

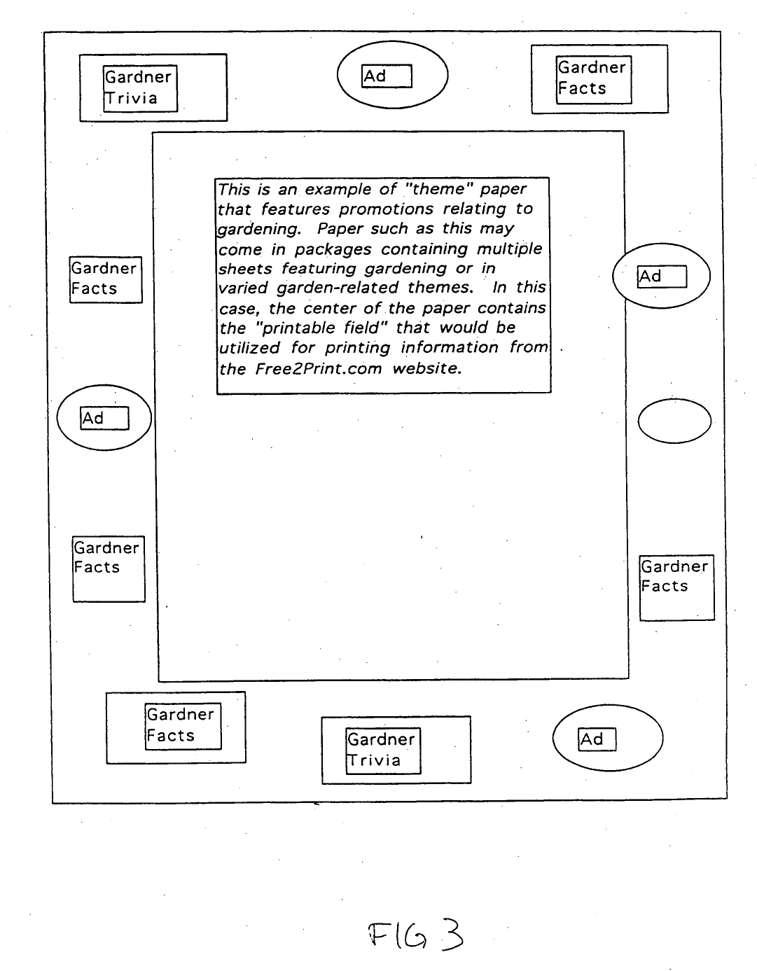

Paper with pre-printed ads can be purchased or ordered for virtually any use and advertisements can be placed or positioned according to the intended use of the paper. For example, a user can purchase paper-with ads printed along a vertical margin as illustrated in FIG. 2 or across the bottom portion of the sheet that would enable use of the rest of the blank space to print from his printer, or any other such purpose, depending on his need. The user can purchase or order customized pre-printed paper with certain categories of ads that are of particular interest to him or to another receiving party. For example, as shown in FIGS. 3 and 4 where the “theme” of the advertising is gardening and sports, respectively. The paper is formatted with a central printable field. Packages containing a plurality of sheets can have the same sports theme or varied sports and sports-related themes.

Paper with pre-printed or embedded promotions can be purchased or ordered for virtually any use and advertisements can be placed or positioned in an infinite variety of ways according to the intended use of the paper. As described, for example, a person could purchase paper with printed promotions on the bottom that enables use of the rest of the blank space to print from a printer, or for any other such purpose, depending on user need, are made available for are made available for purchase or order. Furthermore, customized pre-printed paper with specific categories of promotions that are of particular interest are made available for individual users or user groups. These categories can include sports, trivia, loans, home improvement, beauty tips and the like.

A variety of packages, configurations and channels of distribution can be employed. Pre-printed paper can be made available to users at a multitude of outlets, including local service providers, retailers, via mail order and the Internet. Paper can be given away by businesses such as hotels, airlines, car rental services, supermarkets; or institutions, such as schools and the like. By whatever means or channels the paper is obtained, the user then has the option to go to a website that is established specifically for the purpose to confirm the acquisition of pre-registered paper or to register the paper at that website and receive credits, “Print Points”, be reimbursed for a percentage of the cost of the paper or select a variety of partial or full reimbursement options. For the purpose of further describing the invention and for convenience, the domain names Free2print.com. and PrintPoints.com will be used for convenience to designate websites at which the user can go to or register in order to practice the invention.

The advantage of the invention to the consumer is that the paper is either free of cost, or there is an incremental cost savings because the cost of the paper is subsidized by payments made for the use of the advertising space on the paper. The method of the invention provides advertisers the means to reach consumers in a multitude of ways that has never before been implemented on a one-to-one basis, while letting consumers take advantage of the savings as a natural by-product. The method of the invention creates a unique relationship between the paper print, the consumer and the Internet.

Paper can be packaged with a variety of pre-printed advertisements or packaged by specific categories, regions, sponsors or on the basis of any other specific grouping that is determined to have appeal to users or user groups and that will be supported by marketers. Ordering or purchasing paper with pre-printed advertising presents the user with the opportunity of receiving special game pieces such as scratch-offs, sweepstakes or other promotional items or special printable paper sheets which can be termed “Limited Edition” sheets to be used in conjunction with Free2print.com. When pre-printed paper is requested by specific categories or for specific products, the user/purchaser can optionally be provided with related promotional pieces, and useful related information.

In another particularly preferred embodiment of the invention, a service that is to be provided later via the Internet is purchased and paid for in a transaction in which the paper is acquired. The purchase of the paper off-line, i.e., at a retail store or through other conventional channels, including mail order, entitles the user to subsequently obtain the service, or product, by downloading or printing it from the Internet. In this embodiment, the purchase of the paper is the purchase of the service and/or product. This aspect of the method also contemplates that the paper and/or its user is registered by the service provider, such as, by establishing and maintaining a database of registered users and/or coded or encrypted registration indicia that are printed on the paper and then entered to authorize eventual use when the paper is sold. Registration indicia can be printed directly on the printable paper sheet(s) or other material, printed on an insert placed in a sealed pack of paper sheets, or printed on the sealed packing material in such way that it can only be accessed after the pack is opened. The package is preferably constructed with a tamper-evident seal.

Examples of off-line paper purchase entitling the user to online downloading of valuable information include the sale and registration of the user that permits the user to immediately obtain information on the availability and location of emergency medical services and specialized facilities for a given problem from any given location in the United States, or within a geographical region that is specified by the consumer at that time. The original purchase transaction can provide for a single or one-time access to the sponsor's website or to a plurality of uses, depending upon the consideration paid. For such emergency services, the sponsor preferably provides a logo that can be entered and will appear as an icon on the user's computer monitor or portable computer screen. When accessing the sponsor's website for emergency medical services, the user can identify the location in which the services are required by entering the name of a town, unique landmark, postal zip code, latitude and longitude as provided by a GPS device, or other location indicia.

Other examples of off-line purchasing of online services include special or periodically issued reports, articles, catalogs, repair manuals, artistic and literary works, and essentially any other form of pictorial, graphic, textual information or data that can be transmitted via the Internet. The information can be made available only to an authorized registered user that has completed the on-line or off-line transaction, but the method of the invention can also be employed by businesses that offer a variety of the same or similar services to others for a fee.

In another preferred embodiment, the printable paper sheets are provided with pre-printed marginal areas that bear some special relationship to the information to be subsequently printed, or the paper itself is of a specialized texture or quality. Marginal areas on printable papers sheets on which short stories, children's stories, novellas and the like, that are to be downloaded via the Internet are printed with engravings, lithographic designs or decoration, color fields and the like in a high quality or with greater resolution than would be possible or economically practical using a standard blank ink or even color computer-printer thereby adding a unique value to the document.

For example, a partially-printed admission ticket can be sold on a specific grade or type of printable paper sheet, permitting the user to later select or be assigned the date, time and seat location based on personal preference and availability as determined by accessing the sponsor website. Thus, a concert sponsor can offer a block of high quality pre-printed tickets well in advance of the concert by selling the registered partially-printed tickets at music stores and/or retail locations other than the box office; the purchaser/user enters the registration indicia at the sponsor's website via the Internet; and the user then enters or is assigned date, time and location selection until an availability is confirmed, at which time the rest of the ticket information is printed by the user's printer and the sponsor's database is updated to indicate the allocation of the particular seat and its unavailability to others.

In another particularly preferred embodiment of the invention, so-called Limited Edition sheets are offered for sale and, when purchased, constitute the sale of a product or service, to be printed on the paper or printable material at some future date or dates. Purchasing the paper becomes the act of purchasing the prescribed product or service to be printed on it by an interactive process initiated by the user at a later time. This aspect of the invention is a refinement of the method and business model where the marketer could pre-sell a product or service via the sale of paper off-line and delivers that product or service online.

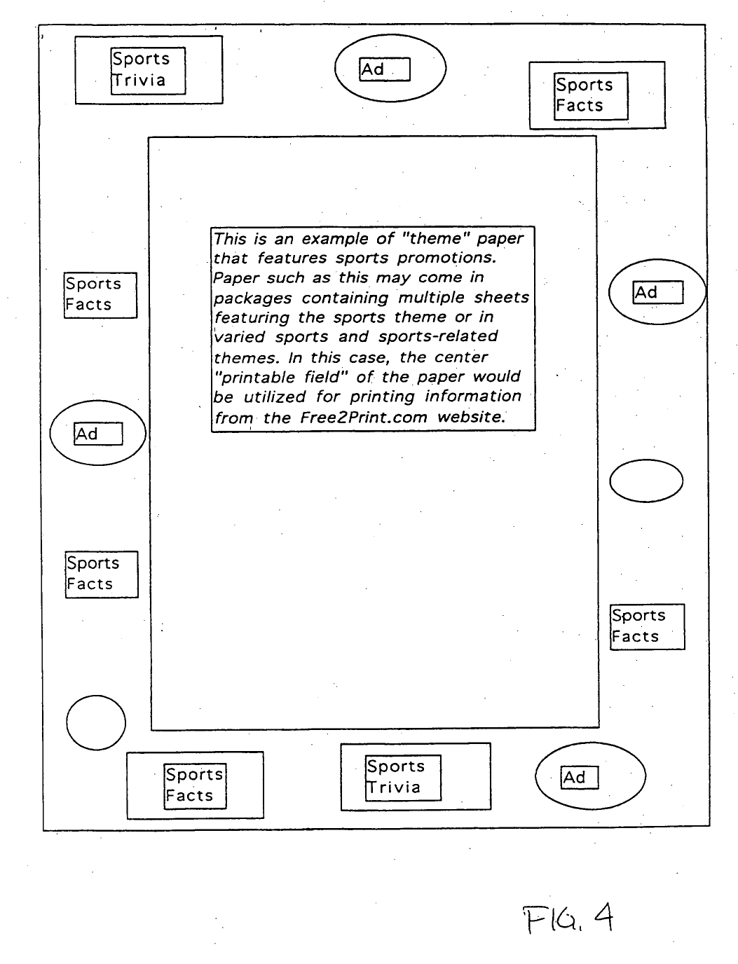

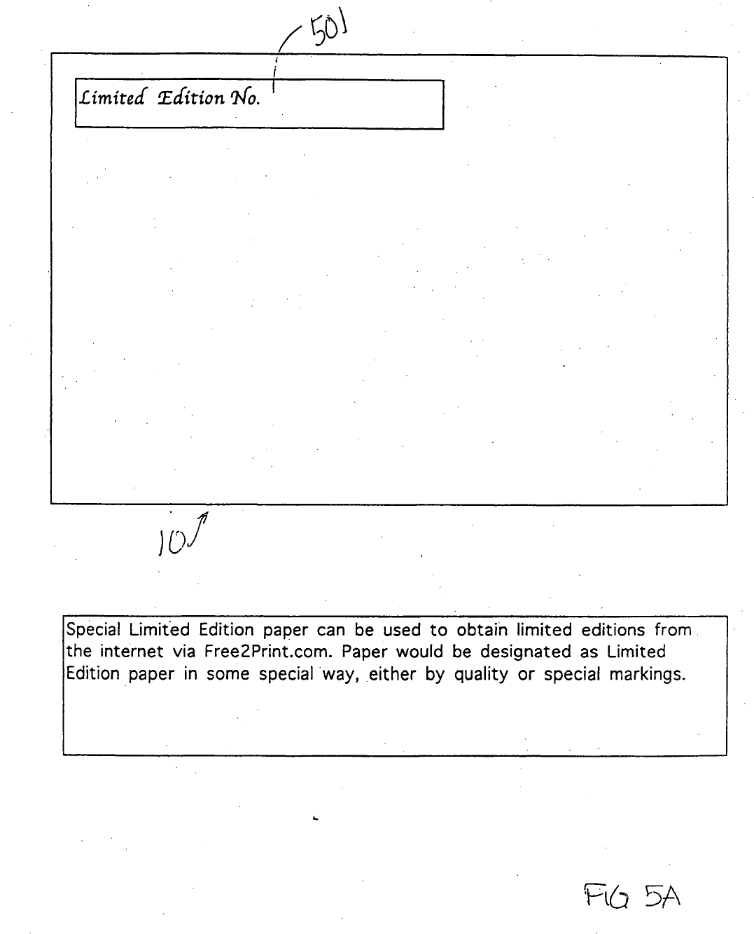

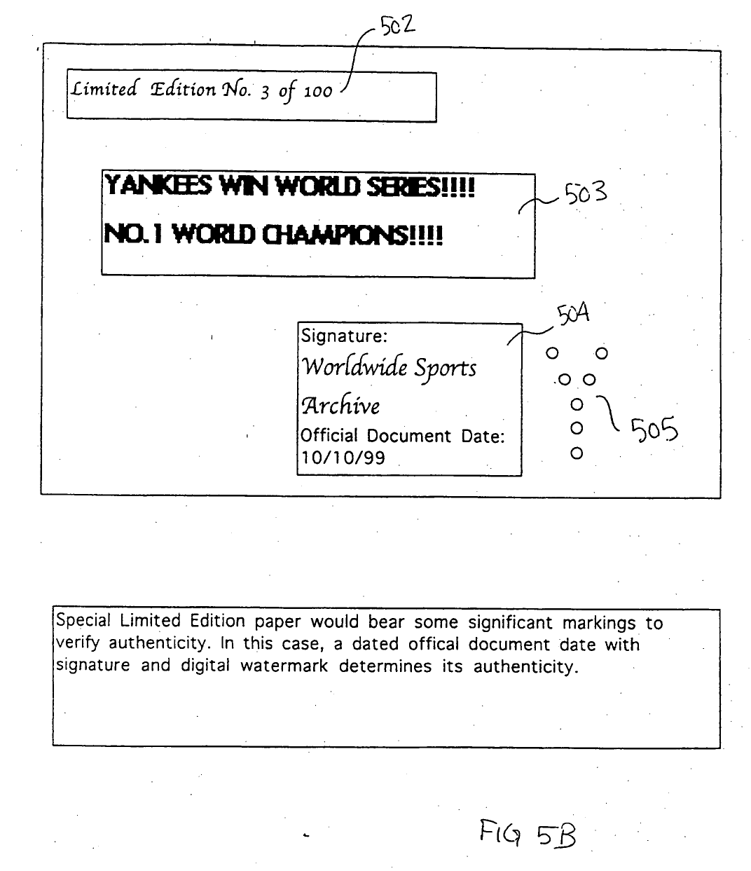

Interactive promotions of Limited Edition sheets can be printed, pre- and post-registered and numbered, purchased, saved as keepsakes, traded or collected. As shown in FIG. 5A, the paper sheet 10 is provided with a printed indicia 501 designating it as Limited Edition paper, or the paper can be of a special quality, color or texture to differentiate it and thereby enhance its apparent value. This specialized product/service can be offered within limited time frames and/or in limited quantities that make them more in demand and valuable. Special paper can have unique properties that may constitute a validation of its Limited Edition status. A limited edition can be offered to users with a specified number of print points. Limited Editions or Limited Edition paper can be sold or given away, and can incorporate a variety of different quantities, qualities and sizes. Validation can be completed with, e.g., date/time stamps, special logos, embossing, digital codes, digital watermarks, printing the paper through several specific websites or any other special process to identify the print as a limited edition using online or offline for signature or validation methods. As shown, for example, in FIG. 5B, the Limited Edition paper is printed with the prescribed information, which can include the number of units 502, an event 503, validation information 504 and a printed watermark 505. Limited edition prints of artwork, photos or poems, as in FIG. 5C with autograph 506 or with personalized messages from the artist or author can be distributed in this manner.

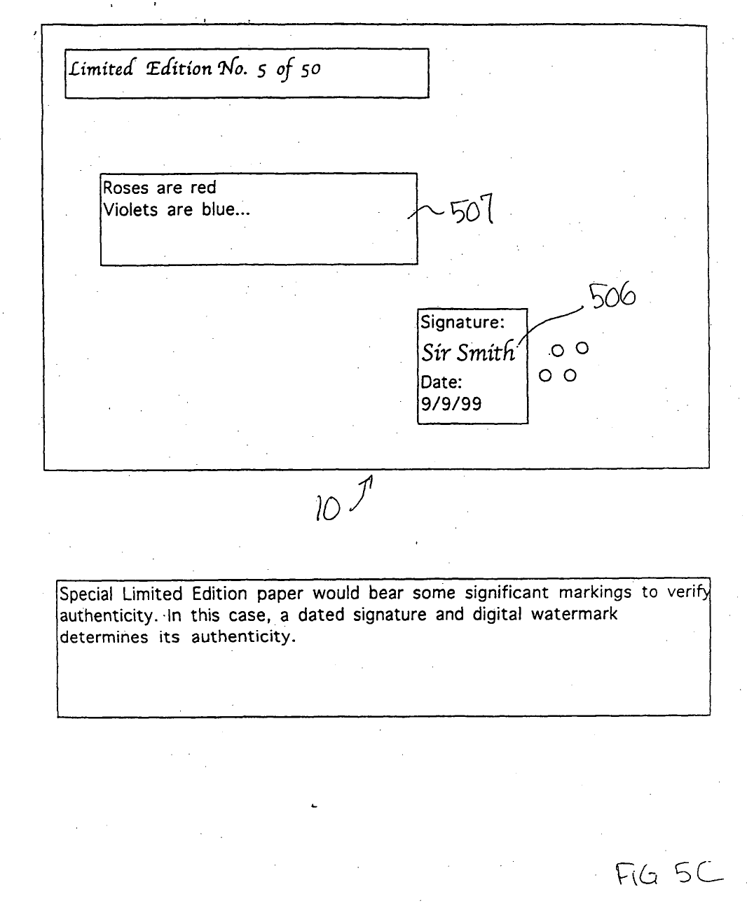

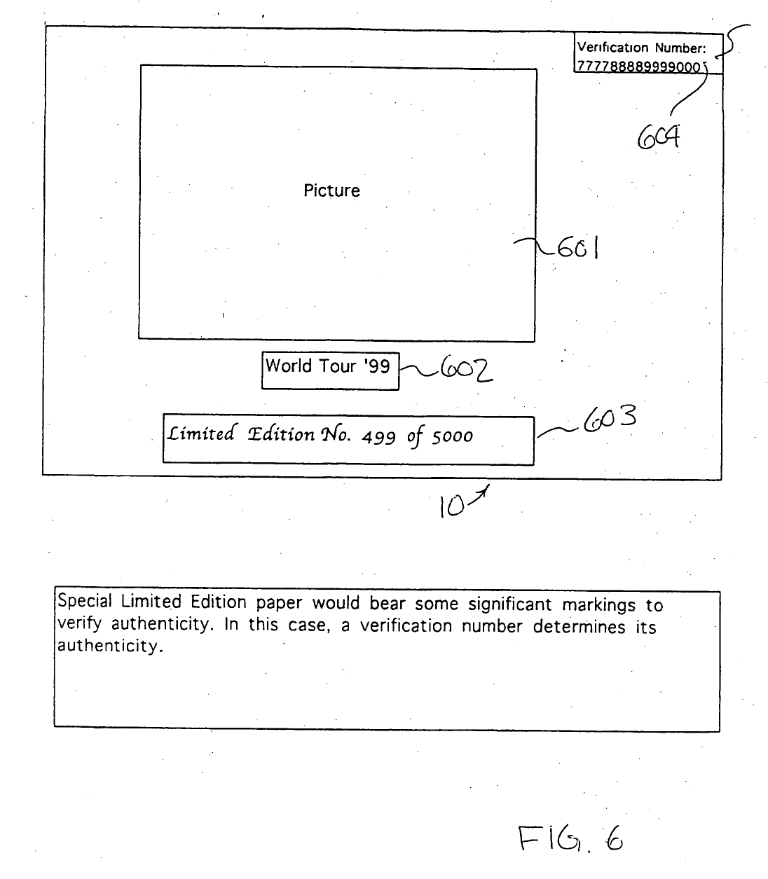

In a further example of the method and apparatus of the invention, a printable paper sheet is sold with a printed image, e.g., the photograph of a well-known sports figure, musician, fan club personality, or the like, for eventual autographing in a “live” ceremony at which time the individual creates an electronic autograph in the context of an Internet interview, after which the autograph is transmitted to those authorized registered users who enter the appropriate verified information for subsequent transmission. For example, as shown in FIG. 6, a photograph 601 is printed on sheet 10, along with some identifying information 602 and the size of the limited edition 603. A verification number associated with the particular print verifies its authenticity, as by registration number. In an especially preferred embodiment, the sponsor offers specialized ink, e.g., gold or silver, new technologies, for use in the user's printer for entry of the autograph on the printable photographic image. Specialized papers, such as those that are acid free, can be offered at a premium or as an incentive to those users who anticipate long-term retention of the printed material.

In a further preferred embodiment of the invention, a package of pre-printed paper can be distributed for particular groups, localities, seasons and times so that users can determine what is relevant to them. A pack of paper can be distributed containing menus for local restaurants, since the Internet now makes it possible to generate daily specials and include real-time coupons as well. Using a “your town” Free2Print pack of paper, information can be generated about tag sales, community events, block parties and other variable information. The paper can be localized, regionalized, or nationalized and be printed fully or partially with menus of local restaurants and coupons for local stores. When practiced via the Internet, users can employ the method and apparatus of the invention to receive, print and e-mail their notices and have them show up in real-time on Free2Print paper and therefore printing can be time and event driven. After selecting an event, the hours and dates, or the directions to an event can be printed and the information is updated to provide useful data in real-time to accompany the original ad.

The method of the invention is compelling to consumers because they have control of information while advertisers supplement the cost of the paper with promotions to get their personalized messages or information on paper and in people's hands, homes and businesses. Whereas most Internet ads are fleeting, temporary and dictated by the site you are on, the invention provides variable and selectable, customized advertisements for the product that are relevant and permanent in the customer's hands. The method is compelling to marketers because when the ad is printed, pre-printed or embedded, it now can be circulated to additional people providing additional sharing of the information. This is because a printed advertisement for a product or service can now be circulated en masse for much less cost than traditional methods, while it has the certainty of reaching its targeted audience. By offering the option of purchasing packs of uniquely grouped and packaged pre-printed paper, advertisers can get, for example, 500 promotions into circulation without the cost of creating a mailing, individually placing an ad in a magazine, placing an ad in a newspaper or other more costly traditional means of promotion. In this embodiment where pre-printed paper is used, it is possible to guarantee that a specified number and type of ads, messages and promotions are configured to go directly into the hands of the customer and beyond. The promotions are physically in the marketplace for a fraction of the cost of other printed media via Free2Print.com, delivering a product people need and use everyday.

As another example illustrating the advantageous practice of this preferred embodiment of the invention, a package of pre-printed paper is distributed for use in a particular locality, so that users can determine what is going on in the neighborhood, find out where there are sales, special offers and events. The paper can be printed with logo, menus of local restaurants and coupons for local stores.

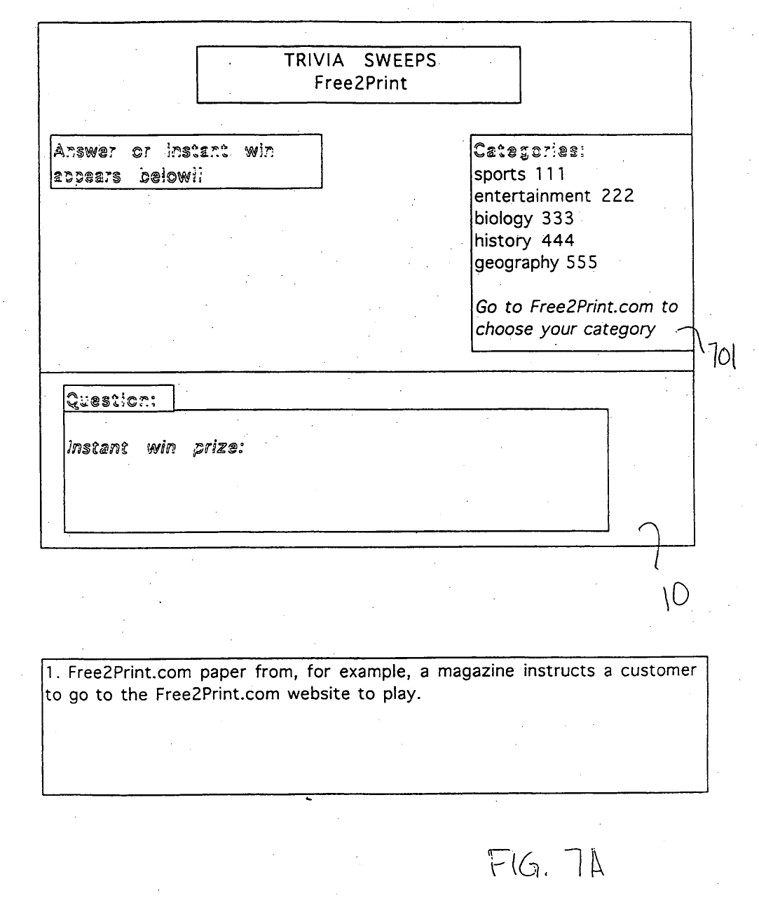

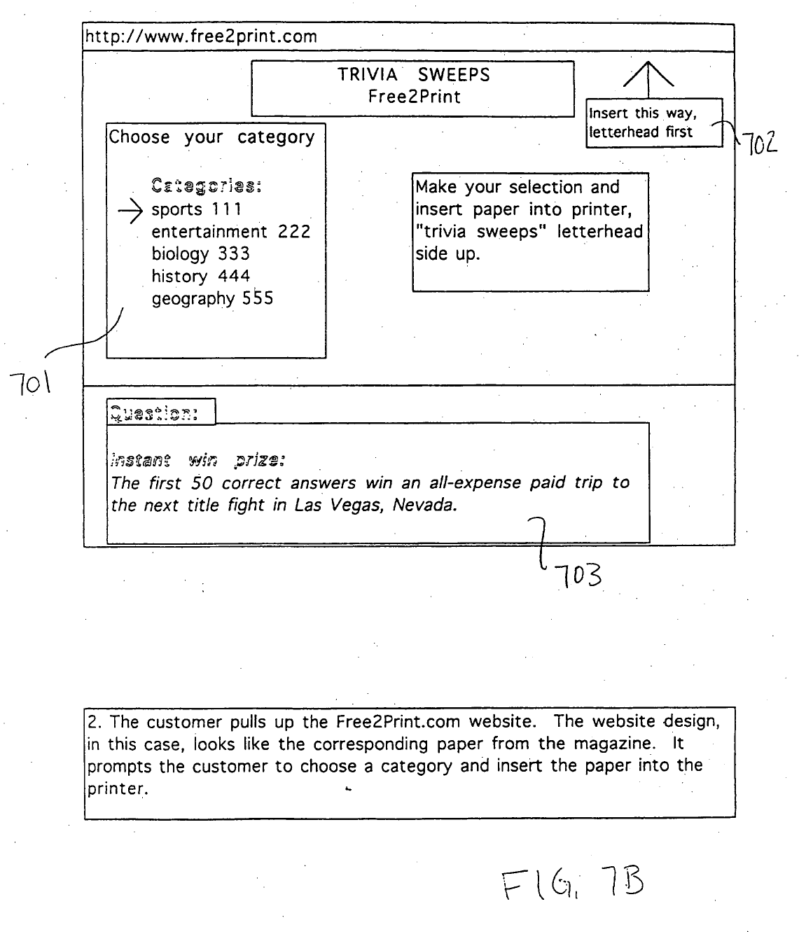

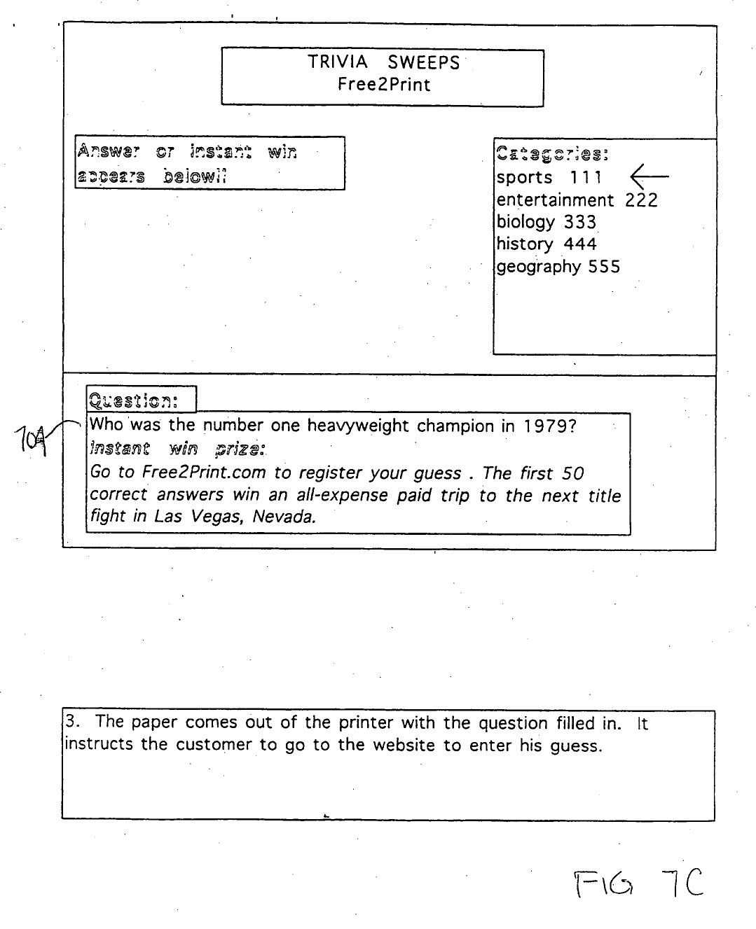

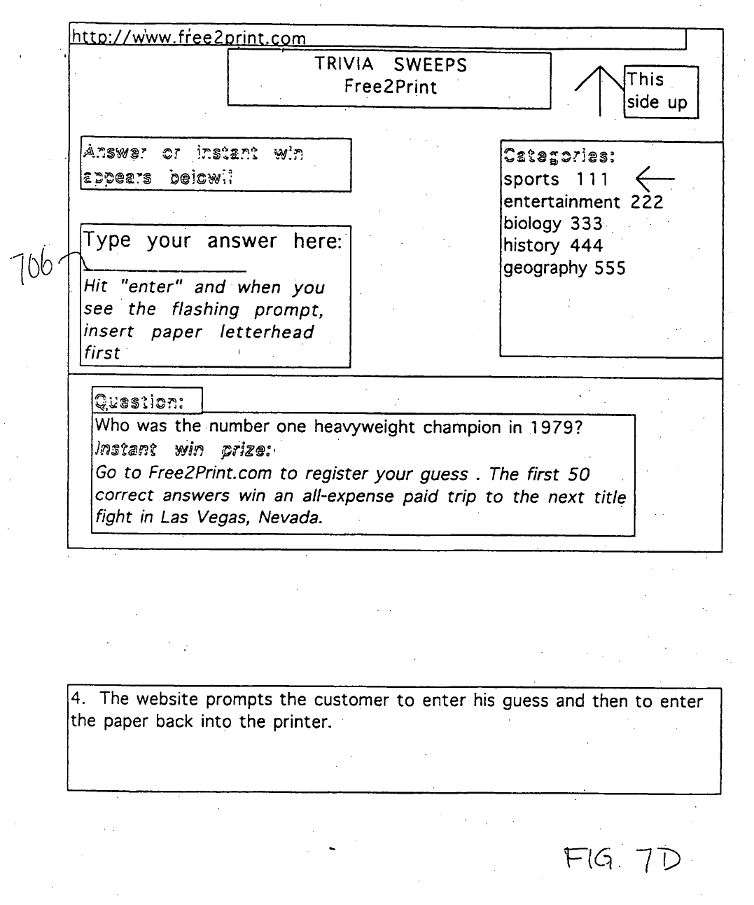

A representative promotional game or sweepstakes, conducted in accordance with the method of the invention will be described with reference to FIGS. 7A-7E. In this illustration, the game or contest requires the user/participant to correctly guess the answer to a trivia-type question in order to gain entitlement to a prize or prizes. The sponsor(s) advertising appears on the user's monitor when the designated website(s) is visited and, in a preferred embodiment, is printed on the contest paper by the user's printer when data is downloaded from the website. Referring to FIG. 7A, a printable paper sheet 10 is shown, which sheet can be in the form of a magazine insert, a randomly-placed sheet from a pack of paper distributed to a registered user, or one of many such sheets in a pack of paper that is devoted only to such promotional games, contests, and the like. A printed instruction block 701 directs the user to the Free2Print.Com website to commence play. FIG. 7B is a representation of the website, the design of which corresponds in elements to those printed on the paper sheet. The user is prompted at 702 to choose a category and to insert the paper in the correct orientation into the user's computer printer. Sweepstakes rules and other relevant information, 703, can also be provided to the participant/user at the website. As shown in FIG. 7C, the user selected the “sports” category and the paper as retrieved from the printer now includes the printed question at 704; the user is again directed to the website to register and enter the answer to the sports trivia question. The website as viewed on the user's monitor is illustrated in FIG. 7D and includes a space 706 for entry of the answer and is also instructed to insert the paper sheet 10 into the user's computer printer. Following processing of the user's answer, an appropriate message is transmitted to the user, where it is displayed on the user's monitor and/or made available for downloading and printing on the contest sheet as shown in FIG. 7E. The sponsor can require that a number of questions be answered correctly in order to win or qualify for a further selection process that eventually leads to the award of a prize.

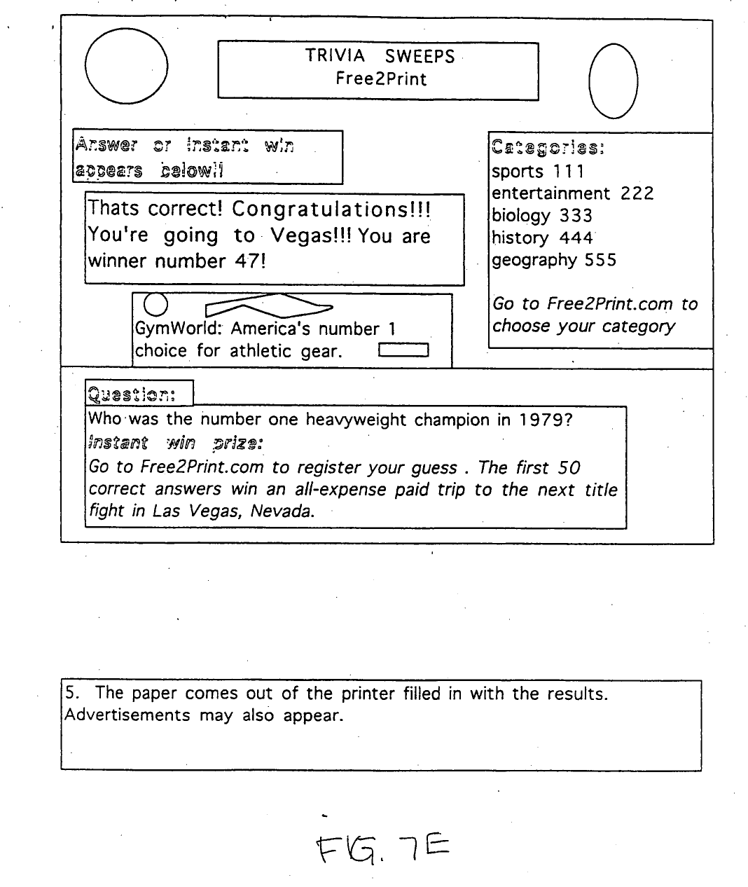

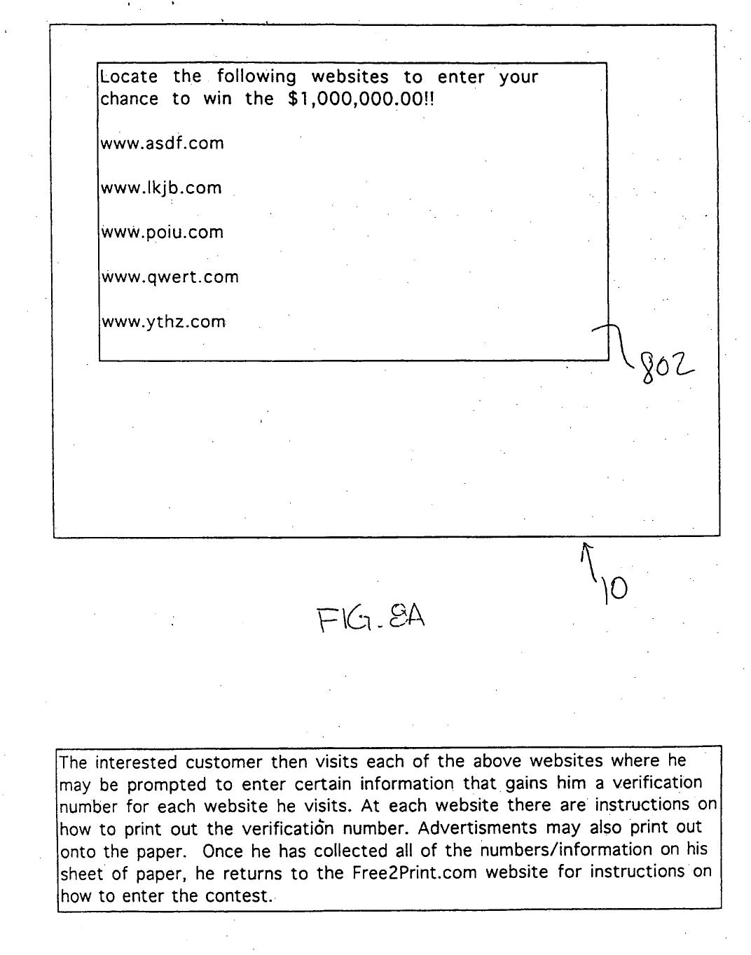

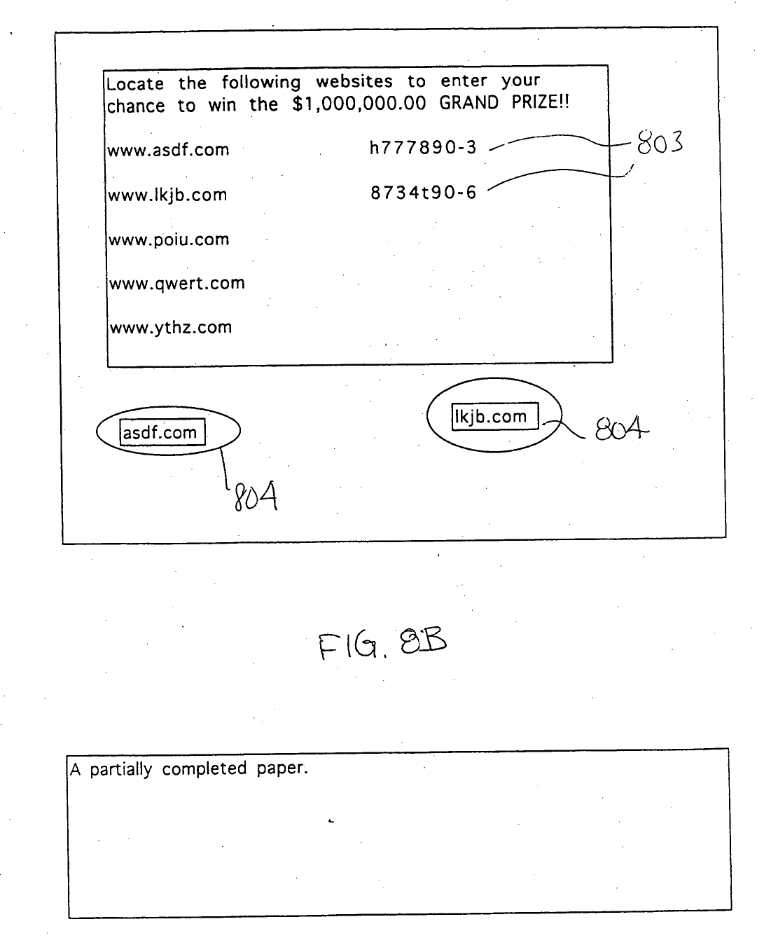

Promotional contests and games sponsored by one or more advertisers can be structured to require the user to visit a number of related and/or independent websites where the user is prompted to enter designated information in order to obtain a verification indicia for each of the websites visited. A typical format is illustrated in FIG. 8A, where a printed on sheet 10 includes an instruction set 802 that includes a plurality of website addresses. As the user visits each website, instructions are provided for obtaining the necessary verification indicia; advertisements can be transmitted for downloading when the user prints the desired verification indicia on sheet 10 by his computer printer. Partially completed sheets as printed by the user are illustrated by FIGS. 8B and 8C; the completed sheet of paper is illustrated following printing by FIG. 8D, which in this embodiment includes advertising messages from the contest sponsor(s). Having collected the necessary verification indicia 803 from each of the listed websites, the user is instructed to return to the Free2Print.Com website for status validation and any additional instructions required for entering or completing the contest play. In this embodiment, a single sheet is completed with printing in a sequence of steps. In an alternative embodiment, a number of separate sheets are printed at different times, (e.g., daily, weekly), in order to obtain the necessary clues, or to provide a mosaic of text, graphics, or other indicia which must be arranged by the user/player in order to successfully complete the promotion and be eligible for a prize, or continuing the play.

In a further embodiment of the invention, an article of costume jewelry, such as a bracelet, pendant, or decorative pin, or a watchband is fashioned, which may be in part, from a transparent material and is so constructed that a piece of appropriately configured printed paper or printable material can be inserted or affixed and made visible through a transparent or exterior wall. In a similar fashion, a badge, plastic cup or mug, a tee shirt with a transparent plastic covered pocket, a calendar frame, refrigerator magnet or other article of personal wear or household item or home furnishing can be provided with a transparent or affixable viewing surface behind which is removably inserted a decorative printed paper sheet or other printable film or material.

In this embodiment, the designer or purchaser of the jewelry, article of clothing or other product is also provided with the opportunity of acquiring different compatible inserts in the future via Free2Print.com. The original purchase price of the article can include registration to obtain one or more replacement inserts by downloading a new and different design that is printed by the owner/user's computer printer. The user can be provided with the option of purchasing a plurality of replacements at the time the original article is purchased, or at a later date. The purchase of printed replacement inserts can include a printable paper sheet containing die-cut and/or perforated elements that are indexed for future printing alignment. In the case of a transparent watchband, a single sheet containing 12 pairs of unprinted replacement insert cut-outs can be laid out on a single sheet which preferably has a release sheet to insure their proper positioning until a pair is removed after printing. The release sheet is provided with a registration number or indicia that permits the user to access the print instructions at the seller's website, i.e., on a variety of options in order to download and receive the necessary instructions for printing a new decorative insert or inserts in a variety of time frames. The inserts can also be customized to provide relevant information, such as a monthly calendar, national and local holidays, important dates such as birthdays, and the like. As will be apparent to one of ordinary skill in the art, the combination of decorative and/or personalized information, when viewed in conjunction with the wide variety of products into which such printed elements can be inserted, is essentially limitless.

The configuration of the display item can also be customized by the user within specified design parameters, e.g., size, shape materials of fabrication, thereby providing for the creation of an infinite number of shapes and designs by users. Each such custom display item will have corresponding custom inserts as described above. The display item can either be special ordered through Free2Print.com or by creating specifications on-line, or via some other medium, or it can be created by an outside source off-line, and the specifications transmitted to Free2Print.com to create the corresponding inserts. This embodiment provides a user with a uniquely customized display item, created to the user's own specifications.

For example, in the case of a watch band, the user can specify the material, width and size of the display band, and can then enter the specifications for producing the insert that would fit into the customized watch band display item. This method can be applied to a variety of display items designed to meet an individual user's needs. Furthermore, the design on the insert(s) for the display can be varied completely by the user's own choosing.

The inserts for the display items can be made of printable materials other than paper, as the technology allows. The insert for a book cover or handbag may be made of cloth, the inset for a jewelry box can be made of a synthetic polymeric material, such as mylar, and the like. A variety of methods known to those of ordinary skill in the art can be employed to join the customized insert to the customized display item.

The shapes and the sized of the display item and/or the corresponding insert(s) can be maintained for viewing in a cataloged database and options can be provided form a library of choices through Free2Print.com which allows designs to be configured in a unique, custom way. The paper or other insertable material can be specially customized as unique designs for a given user.

An example of the practice of one embodiment of this aspect of the invention is illustrated by. FIGS. 11A-11. A watch 150 is provided with transparent straps 152A and 152B formed with a pocket for receiving insertable decorative strips via transverse openings 154A and 154B extending across the surface of rear wall of the pocket. Each of the strap elements 152 is formed by die cutting sheets of superposed polymeric material and bonding the exterior edges together to form the pocket for receiving the decorative insert. The purchase price of the display item watch includes accessing a Free2Print or affiliated website in order to download and print designs of the user's selection for preparing inserts to place in the transparent straps elements 152. As shown in a preferred embodiment of FIG. 11B, printable paper sheet 10 is provided with a plurality of removable insert elements 160A and 160B that correspond to the pockets in transparent display strap elements 152A and 152B. The user accesses the appropriate website, establishes his status and downloads one or more ornamental designs which are then printed by the user's computer printer on sheet 10 in alignment with the corresponding insert elements 160A and 160B. A pair of decorative inserts as removed from the sheet 10 is illustrated in FIG. 11C. As illustrated in the partial view of FIG. 11D, strap element 154A is constructed from upper wall 166A and lower wall 168A that are joined at their edges and form a pocket 170. As illustrated in FIG. 11D, insert 160A is passed through the opening 154A in rear wall 168A, until it is contained in the pocket 170. This operation is repeated by inserting decorative insert 160B in strap element 152B. The display item watch containing the decorative inserts printed by the user is illustrated in FIG. 11E. The designs printed on the inserts 160 while they are integral with sheet 10 can be created by the user while online or chosen from a selection of designs. The display item is coded and this data is also entered by the user to assure that the proper size and configuration is printed by the user's printer on the appropriately configured paper. The purchase price for the display item is variable, depending upon the number and type of printable paper sheets received with the display item, the number and type of designs from which the user's election can be made, or whether the user chooses to make a custom design.

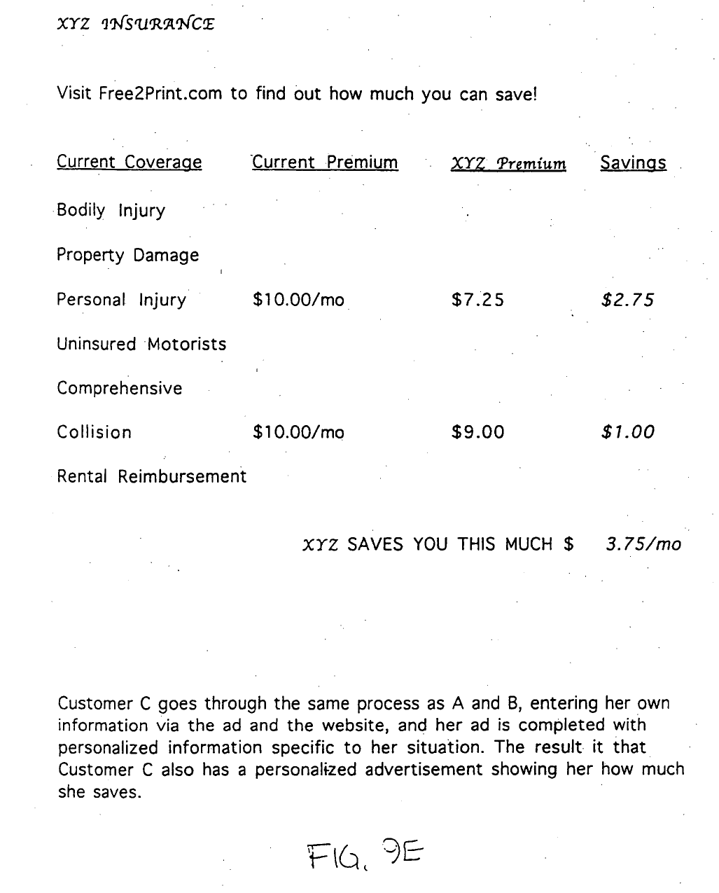

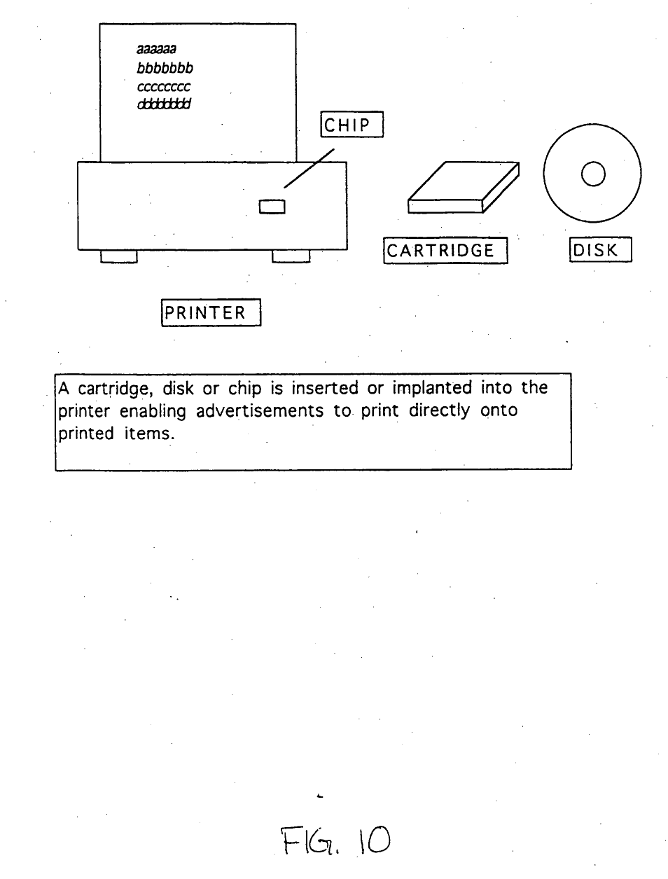

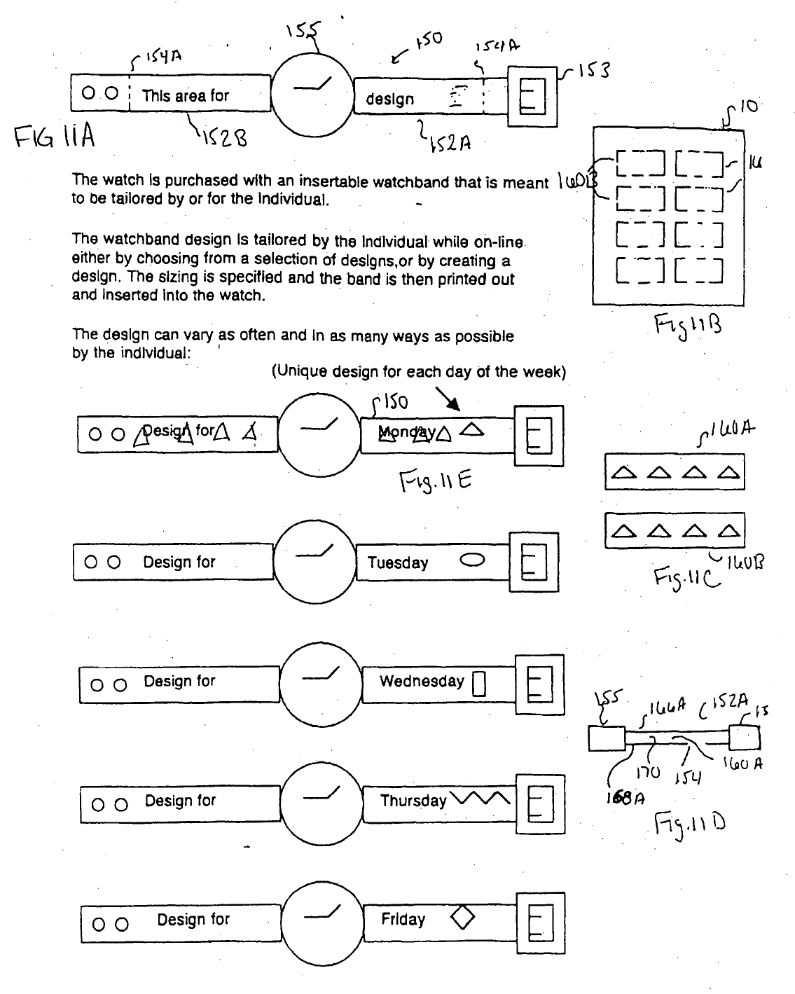

In a further embodiment of the invention illustrated by FIGS. 12A-12D, the display item in the form of a pin or brooch 250 is designed by an individual user as a unique creation. The central display element 252 is transparent and is adapted to receive an interchangeable insert, e.g., by way of a removable rear wall (not shown.) The user transmits the configuration of the central display element 252 to Free2Print or an affiliate and receives one or more printable paper sheets 10, which as shown in FIG. 12B have been provided with a plurality of removable inserts 262 corresponding in size and shape to the central display element 252 of pin 250. The fee charged the user for the sheet(s) 10 includes the right to access a website to enter an appropriate code corresponding to the user's custom configured paper sheet and design, and to download for printing on the user's computer printer the desired design. FIG. 12C illustrates sheet 10 following printing of the removable inserts 262 with, e.g., different colors. The pin with one of the colored inserts 262 positioned in central display element 252 is illustrated in FIG. 12D.

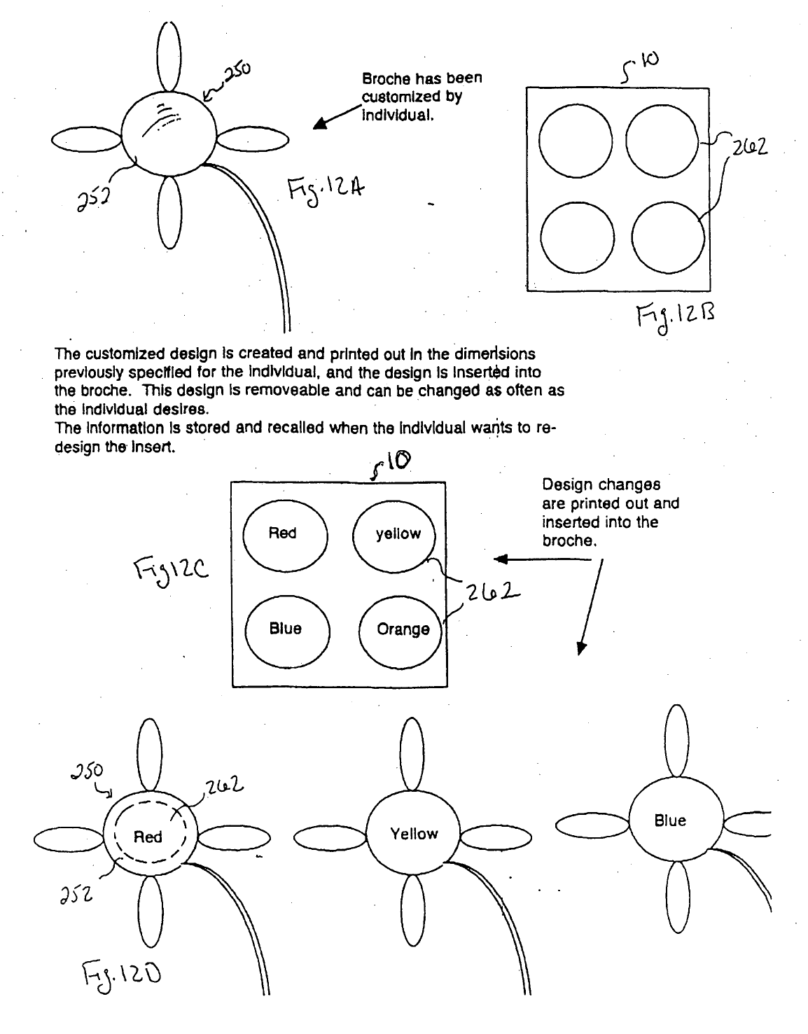

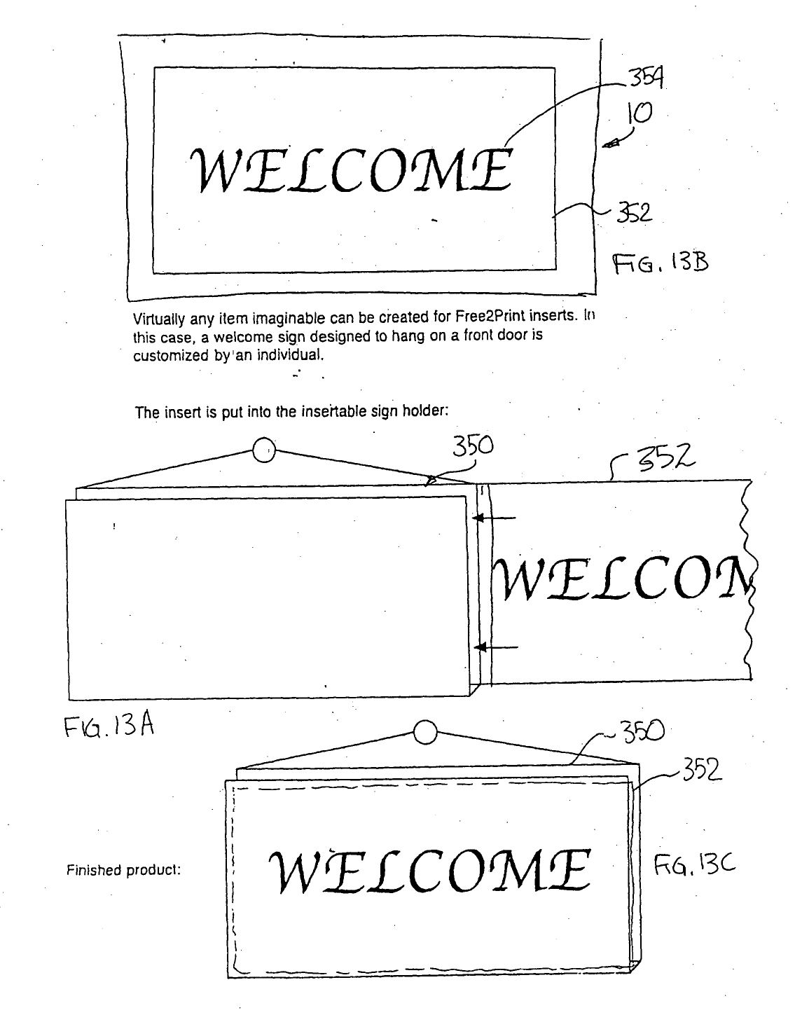

Another example of a display item for use in the practice of the invention is illustrated in FIGS. 3A-13C in which a sign display frame or holder 350 is purchased by the user along with one or preferably a supply of printable paper sheets 10 to be used to download the test and/or designs for sign boards from a website established for that purpose. As shown in FIG. 13B, sheet 10 is provided with a removable display insert panel 352 which is adapted to be inserted into the display item holder 350. The insert panel has been printed with text 354 downloaded by the user and printed on sheet 10 by the user's computer printer. Following removal of the printed insert panel from sheet 10, it is inserted in frame 350 to complete the sign as shown in FIG. 13C.

The method and apparatus of the invention is especially adapted to appeal to large groups of people having special interests. It is well known that a large percentage of people are interested in, and enjoy a variety of activities which fall under the broad category of gambling. These activities include card playing, dice games, horse racing and the like. Examples of the application of the invention to this special interest area includes the distribution of printable paper sheets on which have been pre-printed representations of three of five, or five of seven playing cards, or one of the faces of a pair of dice, the blank faces being completed by placing the sheet in the user's printer and accessing the sponsor's website to download the data required to complete the poker hand or dice roll. Holders of winning hands or dice combinations including all games of chance, such status being determined by the sponsor, are awarded prizes in accordance with established rules of the game or promotional contest.

Horse racing aficionados can purchase registered paper for downloading photo-finishes of specific track races that include the date, the race, the field and its winners, the winning times and the like. The cost of downloading the photographic images can be varied depending upon whether it is printed in black or white or color limited edition, time or event driven.

Fans of other organized sporting events, particularly those that are typically televised, can purchase sheets or packs of paper which authorize the downloading of one or more photo images from a particular team's game or selection of team events. For example, a college or university offers its alumni a pack of printable paper sheets corresponding in number to the number of regular season games and provides one or more particularly dramatic photo images or statistics from each game, one of which can be downloaded onto the paper sheet from a designated website during or after the conclusion of the game. The fully printed sheets can be mounted in a scrapbook, framed or simply retained as souvenirs for their value.

In the practice of the method and apparatus of the invention in conjunction with contests, promotions, lotteries, and the like, the printable paper sheets can be provided with one or more openings, cut-outs or masks adapted to be placed over telephone keypads, computer keyboards or other key devices, with instructions later being provided via the sponsor's website in an interactive game play with authorized registered users of the paper. Packs of paper for sequential playing are sold or offered free in connection with the sale of products and/or services offered by the sponsor.

The purchaser of a piece of equipment, power tool, home appliance, or the like, can be offered a discount for registering the product on-line at the seller's website using a special form provided to the user at the time of purchase and downloading of instruction manuals or service schedules and replacement time or parts for the use and/or maintenance of the article as may be required in the future.

The methods of advertising provided by the invention as described here are especially useful to anyone and everyone looking to cut costs. A company can use pre-printed paper for a variety of printing needs and thereby have its paper costs reduced or completely reimbursed. A significant savings of money can be realized, and a significant amount of publicity and promotions can be achieved in a cost-effective manner for its marketers as well. Advertisements can also be printed directly via printers, cell phones, lap tops, portable printers, palm pilots, remote devices or other specially designed equipment that enables ads to be downloaded or printed or pre-printed with or without direct access to the Internet. In addition to the above means and methods for compensating users, the method of this embodiment can be combined with that described below in conjunction with the Free2print.com website or affiliate websites.

3. Mass Advertising Completed and Customized by User via the Internet.

In another preferred embodiment of the invention, partially-printed advertisements that are distributed by direct mail, pages in publications of general circulation, such as magazines, newspapers and the like, are provided with a sponsor's domain name, or website address or Free2Print code other identifying information in conjunction with Free2Print.com or other website address. An interested user who wishes to obtain customized specific information, e.g., personalized rate quotes for life, auto or health insurance, places the sheet with the partial printed advertisement in the printer associated with his computer, connects via the Internet to Free2Print.com or to the sponsor's interactive website, and with appropriate prompts, enters whatever inquiries or personal information is necessary, and the partially-printed advertisement is completed by the user's printer with customizable information downloaded via the Internet.

A magazine ad can be provided with identifying numbers or other indicia related to different topics, so that a reader can take the ad to his computer or put it in his own printer and enter the identifying information which would automatically print out the relevant information onto the page containing the advertisement thereby completing the advertisement with the information that the customer was looking for so that the ad is now in customized, complete form. This allows the marketer to distribute advertising which attracts the potential customer's general interest without having to provide all of the information at the outset in printed form. The method of the invention also allows each user to get specific, current selected and, therefore, relevant information any time on demand. In this way the Internet can enhance an advertising campaign in real-time and provide the most up-to-date and variable information to prospective customers at any given time.

By giving the consumer options in preparing or completing the promotion, the consumer can customize printed information to produce personally relevant, real-time and real-value, commercial information. The invention permits the finally printed ad to be configured by the user. This allows the vendor to combine the ability to specifically match products, services, information, inventory and data in real-time with the ability to vary information with each and every process each and every time a customer prints out his personalized completed advertisement. The customer interprets what he receives from the commercial message. The partially-printed advertisement copy can vary or be the same for everyone, but following its distribution is personalized by the individual via Free2Print.com. The paper printed format gets the customer halfway therefore; Free2Print.com completes the process. Additionally, any product or service referred to in the ad can have real-time pricing added to it if desired by the marketer. It enables advertisers to consolidate many sites into one and gives the marketer flexibility and options. The customer now has the ability to customize what he sees and receives and can add variable information to the original message. Now the single mass distributed partially-printed ad can be completed in an infinite number of versions.

The advertising method of this embodiment of the invention allows the marketer to customize what it wants to say while at the same time providing consumers with exactly what they want. Instead of hit or miss variations of advertising (the so-called “shotgun” approach) that leave marketers unsure of whether the right information is getting to those who want and need it, a one-page ad can be distributed and in turn generate a million different versions in its completion. The printed promotions can contain more general information about the company and its products, and the Internet or printer can provide specific, up to the minute information about the advertiser's products and services. The pre-printed portion of the ad is designed to be relevant enough to generate the customer's interest and, in turn, the customer then has the power to select the specific information that is unique and relevant to him and him alone.

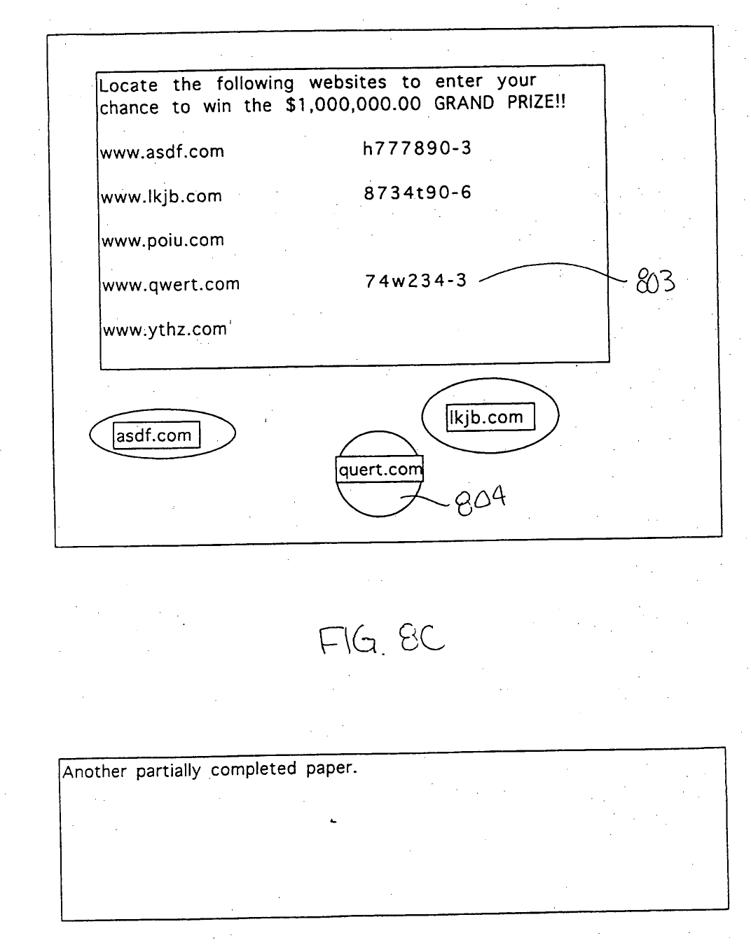

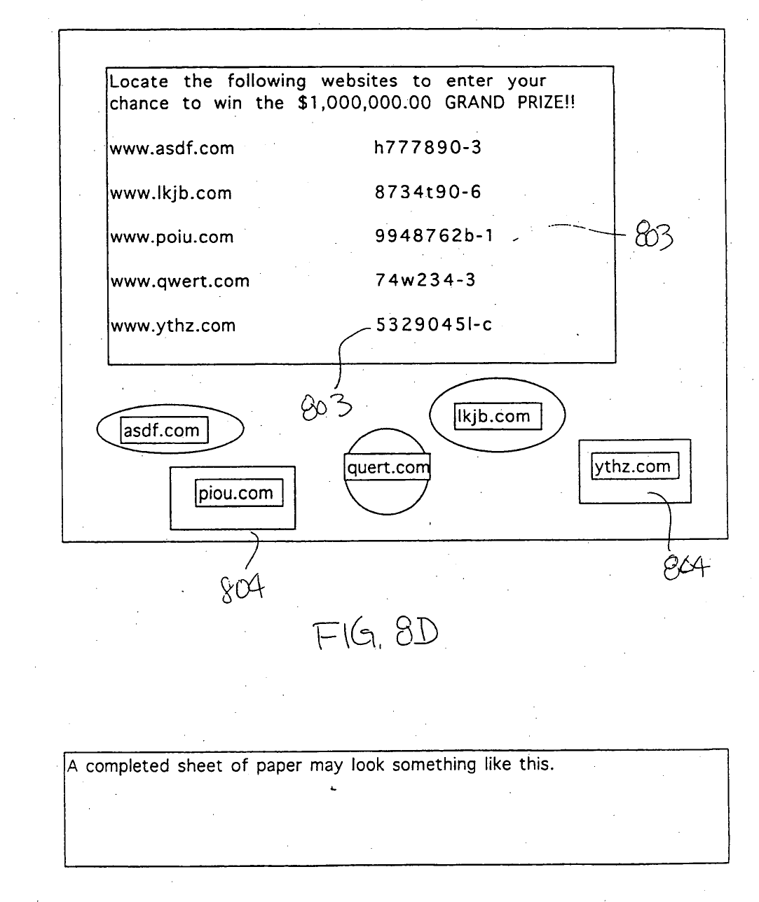

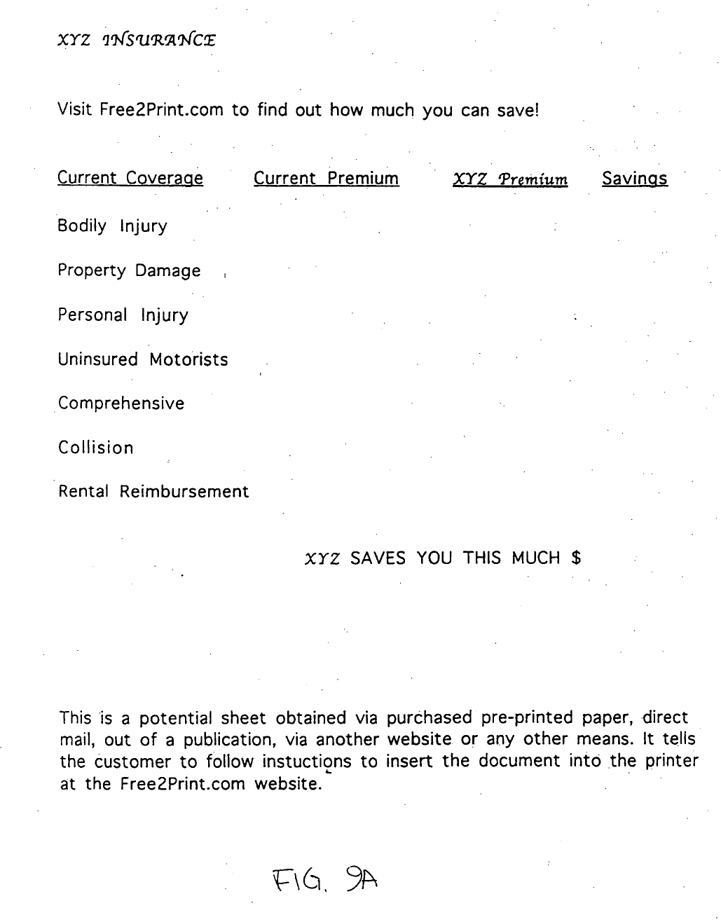

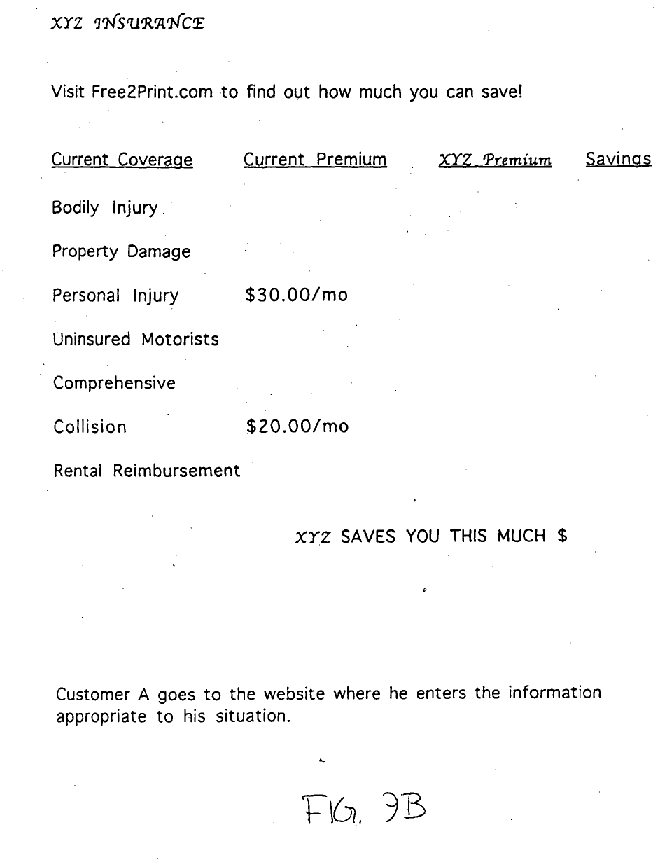

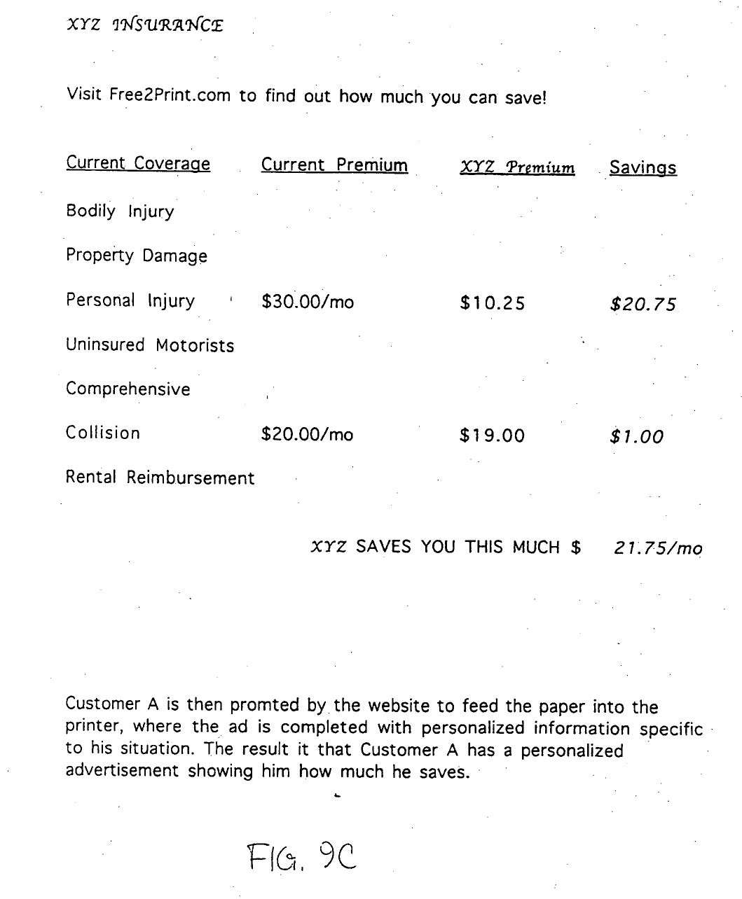

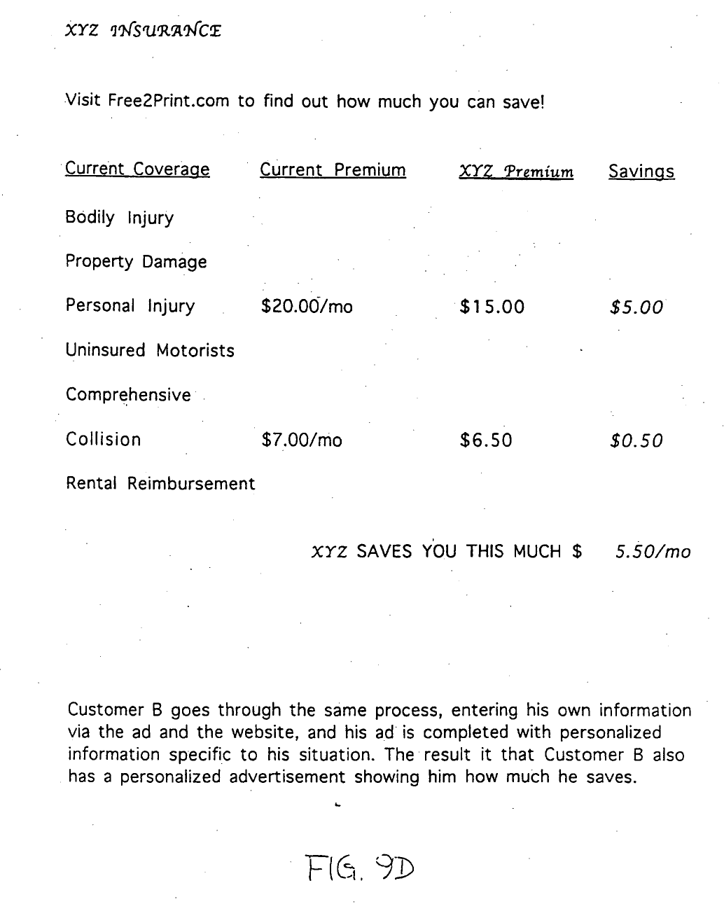

FIGS. 9A-9E illustrate a representative example of the use of the invention by an insurance company or broker in the issuance of personalized quotes to a plurality of readers of a partially printed advertisement published in a magazine, or as a newspaper insert or included with a direct mail solicitation. FIG. 9A is a partially printed paper sheet 10 that includes various categories and headings relevant to the insurance sold by the sponsor and required to provide the desired quotes of premiums based on the desires and personal status of the user. The partially printed sheet is adapted for printing by passing the sheet through the user's computer printer. FIG. 9B illustrates the sponsor's website as viewed by the user after entry of data by the user, and FIG. 9C is the pre-printed sheet after entry of the personalized premium data and savings downloaded from the website and printed by the user. In a further preferred embodiment of the invention, the data is not displayed on the screen until after the printer has printed the additional personalized data. FIGS. 9D and 9E illustrate the resulting completed personalized advertisement sheet obtained by two other users who entered different information and received differing personalized rate quote and savings information.

An ad pack can contain, as an example, 20-50 sheets of pre-printed ads and promotions. Included in every pack there are ads or promotions to supplement or cover the cost of the paper. Combinations of ads and promotions can be sold, with several ads on one page, front & back, embedded, etc. In this embodiment, the ad starts in print form and ends up being a combination of the pre-printed ads and the new information. A pre-printed section can be the same for everyone, but the personalized, variable data can be generated and transmitted to the individual via the Internet to the user's printer. The ad on the paper in pre-printed form is what gets the reader half-way there. The customer can complete the ad by selectable, variable information. Additionally, options can be offered so that any product from any ad can have real-time pricing and inventory added to it at any time. It enables advertisers to consolidate many versions generated from one basic ad into customizable messages.

Using the invention, a person can go directly to a web site with a pre-printed ad, then choose a price range and print out the balance of the relevant items, prices and stores, thus completing the ad. Traditional promotions have a relevance that is lost from the time it is printed to the time that it reaches the customer. Using the method of the invention, each ad becomes a complete and relevant living ad. The customer chooses what is relevant and what is of personal interest. A partial page pre-printed ad can now print out for the interested user every available cabin on a cruise ship based on real-time and individual price range as it varies and is up-dated from minute to minute and individual to individual. The variable information is married up with the pre-printed information to complete the other half of the ad which can be read on screen and preferably printed by the user on the original page.

Via the invention, a user can access a sponsor's web site to choose products in a price color and style range, for example, and then print out those items and prices. In the above example, a cruise line can print out for the individual every available cabin on the ship. The consumer completes the advertising process. Traditional print ads have a relevance that is lost from the time that they are printed. Using the method of the invention, each partially-printed advertisement becomes a living ad. The user chooses what is relevant and what is of personal interest to the user.

Never before has a user been able to individually personalize information from a printed ad, and directly access the information via a central, common website. By combining the two mediums of print and the Internet, each half is afforded the opportunity to do what it does best. The partially-printed copy gets the marketer's message out. The web-produced portion gives consumers specifically customized information about what they want. The invention provides a unique process that interactively brings together print media and the Internet in a mutually beneficial relationship for advertisers and consumers.

To illustrate another example, a landscaping company can recommend specific products to put on a consumer's lawn, customize product lists to a specific location, season, or needs. Retailers can distribute print ads quoting locally determined prices to move the desired inventory at a particular time. Using this invention, it is now possible to provide in print precisely what product a customer wants and finds relevant in real-time. The method of the invention utilizes paper, printers, media and the Internet in a way it was never used before.

From the above, it will be understood that the effectiveness associated with prior art attempts at one-to-one marketing has been flawed and incomplete and is now overcome by the method of the invention, which makes it possible to provide precisely the information desired by the customer and promoted by the marketer creating a marriage of static and real time information.

An advertiser may want to have special features through the Free2print.com website and function as a Free2print.com affiliate. For example, articles in magazines and newspapers could be printed by subscribers. Specified parameters can be established under which users print or use the paper. Users can be required to take an ad to a retail store to match the offer or complete the ad. Special promotions such as lucky numbers contests or special messages to print or complete can be run even every minute or every hour of every day. Advertisers can have special reports and information that could be sold or that would be free to print. Advertising messages can be personalized or customized for registered users. Business can sell by business category so advertiser can match up capacity and inventory, and prospects with their needs. Magazines or advertisements on television can have accompanying reports that could be accessed and be sold or “free to print” through the website. A user can remove a page from magazines, newspapers, direct mail or other printed media that are able to be used in conjunction with a printer to print articles or additional information via particular sponsors. Businesses that typically have catalogs could provide Free2Print paper or sponsor personalized printing of relevant sections or pages, depending on customer interest. This would eliminate the requirement of mass mailings of the entire catalog while still promoting business and providing customers with the relevant, real-time information they want.

The invention also provides the opportunity for advertisers to deliver their message and sell their product without having to create a specific web site. A sponsoring website becomes a local advertising vehicle and each local business advertiser does not have to have every specific address or set up their own website because they can use Free2print.com to manage the entire process. It is a very affordable means for distributing promotions, information, products and services from the smallest to the largest marketers. The website can act as a vehicle to personalize information relevant to the individual in the form of a type of “home” page. The businesses would “pay” for the service of organizing their individual information. In this way there is one central system that would enable communication to occur without having to build new websites.

The concept offers a multitude of possibilities that together represent a unique revolutionary business transaction. The method of the invention offers the potential for directly reaching millions of customers to provide them with a novel means for receiving information and of placing an advertisement in their hands.

4. Advertising Printed by Computer Printer

In a further embodiment of the invention the user's printer is modified by adding control and memory means which cause the printer to print advertising when the printer is activated.

In one preferred embodiment, an integrated circuit, or the IC device or comparable means, is programmed or pre-programmed, or used in real-time to direct the printer to print one or more advertisements from one or more providers of goods or services on each sheet, or on any number or sequence of sheets. The advertising message or messages are printed in one or more advertisement fields of predetermined size and location. The remainder of the printable paper sheet is allocated for printing information downloaded from the Internet or generated off-line with appropriate margins and spacings and without overlap or interference with the advertisement fields.

The control means is activated by specific commands from the user via the computer or printer. The control means can be activated for printing advertising when information downloaded from the Internet or whenever a printable page sheet passes through the printer. The control means can be programmed to automatically adjust the printable field to accommodate the advertising printed, or the printable field size can be adjusted by the user via the computer or printing device in accordance with standard procedures for printer control.

In a variation of this embodiment, the control and memory means can be in a modem or similar auxiliary device located outside of the printer and attached by appropriate cables or conductors; or placed into the central processing unit (“CPU”) of the computer, e.g., in the form of a card, disk, chip or CD ROM of the type used to control other types of peripherals and input devices.

The memory means can be in the form of RAM, flash memory, or can be reprogrammable, e.g., by downloading or inputting new or additional advertising or data in digital form via the Internet or other devices.

The control and memory means also preferably comprises a counter or other device that functions to indicate the number of printable paper sheets or promotions printed with advertising. This affords the user means for determining the extent to which credits or similar premiums have been accumulated, and/or how many additional sheets must be printed with advertising to reach some desired or prescribed number and its corresponding reward.

As will be understood, the method of this embodiment can be adapted and practiced in conjunction with all other aspects of the invention that have been described above.

### CONCLUSION

As is apparent from the preceding description, the several preferred embodiments of the invention provide a novel format and method for distributing, creating, organizing and completing printed advertising that has not previously been contemplated. Most importantly, the preferred embodiments described afford one or more methods that uniquely meet the self-interest of both consumer-users and of marketers.

Never before has a customer been able to individually personalize a promotion or the information desired from a printed ad or other medium, and directly access the information via a central, common website or affiliated site. By combining these media, each is afforded the opportunity to do what it does best. The printed copy gets the marketer's message out. The printer/web produced portion gives the customer an endless variety of information to complete the ad, therefore delivering specifically what the customer wants. The invention provides a unique process that interactively brings together paper, printer, channels of distribution, packaging, information devices and media in a mutually beneficial relationship for advertisers and consumers. It is nothing short of a revolutionary new way to communicate and distribute information, market and sell products and services.

The method combines new use, applications and configurations of elements of media that currently have limited applications and creates limitless possibilities. The method of the invention offers companies the potential to directly reach millions of customers to provide them with a unique, new, useful, cost-effective way to disseminate and receive information, and offer products and services in a manner that has never been done before.

I claim:

1. A method of distributing targeted content to a user, said user having offline content containing a partial message from at least one of a plurality of content providers, said method comprising the steps of:
defining a database at a first location; said database comprising updateable real-time, event-driven messages provided by said at least one of said plurality of content providers;
said user:
registering at said first location to generate a profile of user information;
accessing, via a network, at least one second location associated with at least one of said plurality of content providers;
querying said database to retrieve at least one of said real-time messages related to said partial message and said user profile information;
supplying, via said network, said user with said at least one of said real-time messages to supplement said partial message to customize said offline content message to said user;
compensating, via said first location, said user in connection with said supplied message; and
said user redeeming said compensation for authorized goods and services.

2. The method as in claim 1, wherein said first and at least one second locations are website locations on said network.

3. The method as in claim 1, wherein said at least one of said plurality of content providers includes an advertiser or an affiliate of said advertiser.

4. The method as in claim 1, wherein said offline content includes newspapers, magazines, newsletters, billboards, radio, television, or other audio/video/textual/graphical pre-generated media.

5. The method as in claim 1, wherein said processor is further adapted to: maintain an account for said user for receiving and managing said awarded compensation.

6. The method as in claim 1, wherein said compensation is redeemable rewards or points.

7. The method as in claim 1, wherein said authorized goods include additional content.

8. A system for distributing promotional messages to a user having offline content containing partial information from at least one of a plurality of content providers, said system comprising:
a first location for receiving user information;
at least one second location associated with said at least one of said plurality of content providers;
a user device for accessing said first location to provide said user information;
a database comprising updateable real-time, event-driven content messages received from said at least one of a plurality of content providers;
a processor coupled to said user device, database and said first and second locations; said processor adapted, in response to said user accessing said second location, to:
query said database to retrieve at least one of said real-time messages related to said partially complete information and said user information;
supply said user with said real-time content message to supplement said partial information to customize said offline content message to said user;
compensate said user in connection with said supplied message; and;
facilitate said user in redeeming said awarded compensation for authorized goods and services.

9. The system as in claim 8, wherein said first and second location are website locations on a network.

10. The system as in claim 8, wherein said at least one of said plurality of content providers is an advertiser.

11. The system as in claim 8, wherein said offline content includes newspapers, magazines, newsletters, billboards, radio, television, or other audio/video/textual/graphical pre-generated media.

12. The system as in claim 8, wherein said processor is further adapted to: maintain an account for said user for receiving and managing said awarded compensation.

13. The system as in claim 8, wherein said awarded compensation is redeemable rewards or points.

14. The system as in claim 8, wherein said at least one of said plurality of content providers communicates with said processor to provide said updateable messages for storage in said database and to further award said user with a promotional compensation.

15. The system as in claim 8, wherein said authorized goods include additional content.

16. A system for distributing promotional messages to a user having offline content containing partial information from at least one of a plurality of content providers, said system comprising:
a first location for receiving user information;
at least one second location associated with said at least one of said plurality of content providers;
a user device for enabling said user to access said first location to provide said user information; said user device being adapted to execute an application program having a selectable print action;
a database comprising updateable, real-time, event-driven messages received from said at least one of said plurality of content providers;
a processor coupled to said user device, database and said first and second locations; wherein, in response to said user accessing said at least one second locations and selecting said print action, said being processor being adapted to:
query said database to retrieve at least one of said real-time messages related to said partially complete information and said user information;
supply said user with said at least one of said real-time messages to supplement said partial information to customize said offline content to said user;
compensate said user in connection with said supplied message; and;
facilitate said user in redeeming said awarded compensation for authorized goods and services.

17. The system as in claim 16, wherein said user device includes a printing medium; wherein, in supplying said user with said at least one of said real-time messages, said processor being further adapted to:
send said at least one real-time message to said user device for printing on said printing medium; and;
compensate said user in connection with said printing of said at least one real-time message on said printing medium.

18. The system as in claim 16, wherein said first and second location are website locations on a network.

19. The system as in claim 16, wherein said at least one of said plurality of content providers is an advertiser.

20. The system as in claim 16, wherein said offline content includes newspapers, magazines, newsletters, billboards, radio, television, or other audio/video/textual/graphical pre-generated media.

21. The system as in claim 16, wherein said processor is further adapted to: maintain an account for said user for receiving and managing said compensation.

22. The system as in claim 16, wherein said compensation is redeemable rewards or points.

23. The system as in claim 16, wherein said at least one of said plurality of content providers communicates with said processor to provide said updateable messages for storage in said database and to further award said user with a promotional compensation.

24. The system as in claim 16, wherein said authorized goods include additional content.
